(19) United States
(12) Patent Application Publication
(10) Pub. No.: US 2009/0136087 A1
(43) Pub. Date: May 28, 2009

(54) Replacement Based Watermarking

(76) Inventors: Joseph Oren, White Stone, VA (US); Robert Schumann, Oakton, VA (US); Guillaume Mercier, Bourlon (FR)

Correspondence Address: DOLBY LABORATORIES, INC., 999BRANNAN STREET, SAN FRANCISCO, CA, 94103, US

(21) Appl. No.: 12/323,681

(22) Filed: Nov. 26, 2008

Related U.S. Application Data
(60) Provisional application No. 60/990,859, filed on Nov. 28, 2007.

(51) Int. Cl. G06K 9/00

(52) U.S. Cl. 382/100

(57) ABSTRACT

A video processor for replacement based watermarking may include a video content input channel; a video content preprocessor; a replacement based watermarking (RBW) metadata creator; and a video content encoder. To output the encoded video content, the video processor may have a dual or single output channel. For a dual output channel, the video processor includes an encoded video content output channel and an RBW metadata output channel for outputting encoded video content and RBW metadata as separate streams for further processing and distribution. For a single output channel, the video processor includes a video content output channel for outputting encoded video content combined with RBW metadata as a single output stream for further processing and distribution.

### CROSS REFERENCE TO RELATED APPLICATIONS

The present application claims the benefit of provisional patent application Ser. No. 60/990,859 to Oren et al., filed on Nov. 28, 2007, entitled “Replacement Based Watermarking,” which is hereby incorporated by reference.

### BRIEF DESCRIPTION OF THE DRAWINGS

FIG. 1 shows an example of a traditional single-ended watermark.

FIG. 2 shows an example of a block diagram of a video processor as per one aspect of the present invention.

FIG. 3 shows another example of a block diagram of the video processor as per one aspect of the present invention.

FIG. 4 shows another example of a block diagram of the video processor as per one aspect of the present invention.

FIG. 5 shows another example of a block diagram of the video processor as per one aspect of the present invention.

FIG. 6 shows another example of a block diagram of the video processor as per one aspect of the present invention.

FIG. 7 shows an example of a Replacement Based Watermarking (RBW) system.

FIG. 8 shows another example of an RBW system.

FIG. 9 shows an example of an RBW model for a consumer application.

FIG. 10 shows an example of RMP_OpenInstance code.

FIG. 11 shows an example of RMP_CloseInstance code.

FIG. 12 shows an example of RMP_CfgMode code.

FIG. 13 shows an example of RMP_CfgMessage code.

FIG. 14 shows an example of RMP_CfgFrameBufferCallback code.

FIG. 15 shows an example of RMP_StartProcess code.

FIG. 16 shows an example of RMP_KillProcess code.

FIG. 17 shows an example of RMP_AnalyzeVideo code.

FIG. 18 shows an example of RMP_FlushInstance code.

FIG. 19 shows an example of RMP_RetrieveFrameBuffer code.

FIG. 20 shows an example of sizes for Output Data Structure.

FIG. 21 shows an example of a synchronous code.

FIG. 22 shows a continuation of the above exemplified synchronous code.

FIG. 23 shows an example of an asynchronous code.

FIG. 24 shows a continuation of the above exemplified asynchronous code.

FIG. 25 shows phases of RBW carrier Packaging in the RBW Pre-Processing stage as per one embodiment of the present invention.

FIG. 26 shows an example of an Application Integration model.

FIG. 27 shows another example of an Application Integration model.

FIG. 28 shows definitions for the Message Encoding API.

FIG. 29 shows an example of the implementation of Message Encoding API.

FIG. 30 shows an example of a flow diagram of video processing as per one aspect of the present invention.

FIG. 31 shows another example of a flow diagram of video processing as per one aspect of the present invention.

FIG. 32 shows another example of a flow diagram of video processing as per one aspect of the present invention.

FIG. 33 shows another example of a flow diagram of video processing as per one aspect of the present invention.

FIG. 34 shows another example of a flow diagram of video processing as per one aspect of the present invention.

### DETAILED DESCRIPTION OF THE EMBODIMENTS

I. Glossary of Replacement Based Watermarking Terms

Application Message (or Message): An array of bits (e.g., 64 bits, etc.) that is to be secretly embedded into the video stream. The format of the message may be customized for any specific application. The format of the message may be defined in the Application Message Format documentation. The bits are used to embed information, such as the playback device and date/time of the playback. As an embodiment, the present invention allows for a default application message.

Carrier (or Replacement Data Block Carrier or RBW Carrier): A structure that encapsulates a Replacement Data Block. The data may include a pointer to a specific location within the content stream, a length (such as in bytes), and replacement video data. The location may be a specific point in the video stream (compressed or uncompressed) where the Replacement Data Block may be placed. The value of the current Encoded Message bit may determine whether a replacement actually takes place during playback.

Enabled (or Conditioned) video (also RBW-enabled video/content): A video stream that has been prepared by the Replacement Based Watermarking Pre-Processing system. The video stream may contain Carriers either in the video data or in the transport structure.

Encoded Message: To survive a number of possible video transformations, the Application Message may be encoded using a number of error-control encoding techniques. The original Application Message may be determined using decoding algorithms in the Replacement Based Watermarking Recovery system. For instance, the bit array representing the encoded message may be 139,264 bits (17K bytes) long, and the original Application Message may be 64 bits.

Insertion: The act of replacing a portion of the media stream with a Replacement Data Block.

Marked video: An RBW enabled video stream (conforming to a codec such as Moving Pictures Expert Group (MPEG)) which has been through the insertion process. A Replacement Based Watermarking Recovery system may process digital video derived from this stream to determine the original Application Message. Carrier data in the original stream may be cleared (deleted or overwritten with binary 00's).

RBW metadata: A collection of Carrier structures pertaining to a specific video content stream.

Replacement Data Block: A block of data that can replace an original portion of a multimedia data stream, such as an MPEG video stream. After replacement, the resulting stream should still be valid, but may decode to a slightly modified baseband.

II. Forensic Watermarking

Embodiments of the present invention perform forensic watermarking. Forensic watermarking includes steganographic techniques that aid content providers in tracking content instances to specific locations. As one example, forensic watermarking can be useful in monitoring the integrity of Data Rights Management (DRM) systems and Conditional Access (CA) systems. DRM systems include technologies used by publishers to control access to digital data (such as software, music, movies) and hardware. DRM systems can also handle usage restrictions associated with a specific instance of a digital work. CA systems provide to content protection, where certain criteria are to be met before granting access to the content. CA systems are commonly known to be related to digital television systems, such as satellite TV.

DRM and CA systems are used to control access to content. In recent years this functionality has matured from just “scrambling” the channel to actual encryption and management of complex sets of permissions that define how the content may be used by the consumer. As DRM and CA functionality merge, the term DRM is becoming the superset of content protection, which includes CA, content protection and content rights. Within the newer markets of Internet Protocol Television (IPTV) and mobile content, DRM and CA are increasingly integrated into a single offering. This trend will follow over time in legacy markets such as satellite and cable. High value content delivered as Video-on-Demand (VOD), high profile live events (e.g., sports, concerts, news, radio shows, etc.), and high definition content will need comprehensive protection in new and legacy markets.

Digital watermarks are data embedded into digital audio and video that may be readable by computers. Watermarks may be used for various purposes. One type, forensic watermarks, is used to identify the source and/or distribution path (e.g., source of copying) of unauthorized copies of legitimate content. An example of a distribution path is the specific set-top box that was used to render the content for copying. These marks should, inter alia, be invisible (or inaudible), persist through transformations applied to the video, and be recoverable with sufficient integrity to constitute evidence in legal processes.

Forensic watermarking is an anti-piracy tool that compliments DRMs and CAs. Forensic watermarking can be defined as the embedding of a message within the video that identifies the last authorized party in control of the content instance. A forensic watermark can be placed in content at various points along the distribution chain. If content is found outside of an authorized distribution path, the forensic watermark contained in the content can be used to identify the source of the leak.

Today, content distributors and system operators often insert a watermark that identifies the system operator. This practice is often of limited help in identifying pirates. It may be the case that system operators are much more interested in placing a forensic watermark at their head-ends, at interim points along the distribution path, and in the consumer playback device itself. This systematic use of forensic watermarks can, at the very least, identify most of the path(s) to an authorized consumer and eliminate the opportunity for anonymous redistribution. It may also provide a way to monitor the overall integrity of DRM and CA systems. Such monitoring helps raise awareness of when a leak is present so that a system operator can adjust or renew their security system to prevent or stop such leak.

Forensic watermarking has already proven very useful in professional video applications, including for example pre-release movie screeners on DVD. RBW technology has been specifically designed to enable forensic watermarking in consumer applications.

A forensic watermark solution for consumer markets should work across a broad range of playback devices, including, but not limited to, personal computers, set-top boxes, portable media players and mobile phones. To support such a wide range of playback platforms, the forensic watermark should be robust but also require minimal processing resources to insert a message. Also, to provide countermeasures against attacks specific to the watermark(s), the watermarking technique should be renewable without having to update the deployed consumer playback devices. Additionally, to track the path of distribution, the forensic watermarking system should support multiple insertions of marks and be able to recover such marks without any reference to the original digital video content.

Various advantages exist for some RBW embodiments directed to consumers. For example, a “compute-efficient” watermark inserter can be deployed across the entire field of consumer digital media players, including currently fielded models. The “compute-efficient” watermark inserter may insert a unique identifier, such as device ID and date/time of playback. Another advantage is that the system is renewable and can support a “blind” watermark recovery system that requires no information about the original source content, channel of content distribution, or player. Source based recovery is also available with no change to the playback watermark inserter. Yet another advantage is that watermarks can be inserted in the compressed domain so that the mark can be implemented inside the playback system security perimeter. Yet a further advantage is support for multiple watermark insertions so that marks can be inserted along the path of distribution, as well as during playback by the consumer.

Some forensic watermarking technologies may be used in the consumer market to solve critical content rights problems. One such problem is movie content piracy—particularly involving early release (premium) content. However, forensic watermarking may also be useful in monitoring the integrity of a distribution channel, thereby protecting the revenue stream of the system operator by identifying where their system is allowing unauthorized access to programming. This testing may become particularly important as DRMs become more interoperable and the content distribution path includes two or more DRMs, and where system operators want to expand into new types of services, such as network hosted personal video recorders (Virtual PVRs).

To the content owner, forensic watermarking may provide a definitive link between a pirated copy of their content and the legitimate channel where the copy originated. This technology has proven to be a useful tool for identifying and tracking down large scale and individual pirates.

To the system operator, forensic watermarking may provide a tool to positively link (or disassociate) a pirated copy of content to their distribution system. This usage allows system operators to identify where security in their system needs to be renewed. Once identified, system operators may be able to better manage their operating costs and reduce revenue losses by addressing the specific leak(s). It may also mean that they obtain content on more favorable terms, and thus increase the value of programming.

To the consumer, forensic watermarking may act to “keep honest people honest.” In the same way that a consumer will not try to steal clothing from a shop with sensors at the door, that same consumer would not illegally distribute content that had a watermark that could be tied back to them.

Forensic watermarking may supplement some DRM systems. In some applications, forensic watermarking may be used to continue to provide protection once the content leaves the cryptographic protection provided by the DRM.

III. Approaches to Forensic Watermarking of Video

Elements of a forensic watermarking system may include embedding a unique digital message that identifies a device or transaction into the audio or video stream. Embedding may be accomplished by using (1) a video processor that conditions the video stream and creates RBW metadata and (2) a watermark inserted that uses RBW metadata to efficiently embed the message into the video data. Another possible element is the subsequent recovery of that message. Furthermore, the presence of the embedded message must not impact the viewing experience.

A forensic watermark should be robust against directed (specific to the watermark) and incidental (transformations unrelated to the watermark) attacks between the time it is inserted and when it is recovered. For consumer markets it may also be critical that the forensic watermarking system be renewable without having to upgrade the consumer playback devices.

Steps to embedding a forensic watermark include determining where to place the mark; determining what changes are acceptable at the location; and using a specific combination of changes to convey a desired message. The first two steps can comprise an analysis phase. The third step can comprise an insertion phase.

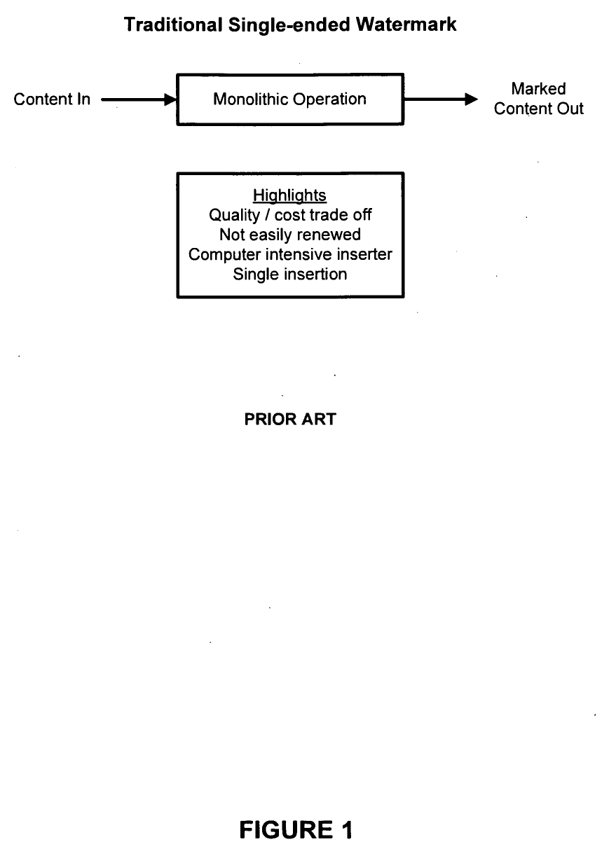

Some forensic watermark solutions treat these three steps as one monolithic operation (“single ended”). FIG. 1 shows an example of a traditional single-ended watermarking architecture. This single ended approach often leads to several problems. First, in order to insert a message that is imperceptible and robust, the analysis component is computationally intensive. This step may add significant costs to the inserter and impose a trade-off between cost and quality. Second, it may be problematic to renew the algorithms used in the analysis phase if the watermarking method is compromised as doing so would require each fielded device to be upgraded.

A single ended system may require significant computational and memory resources. These system requirements may limit the viability of platforms in the consumer marketplace.

Embodiments of replacement based watermarking as per the present invention may be used instead of a “single ended” system.

IV. Video Processor

Several embodiments will now be described in detail with reference to the accompanying drawings. It should be understood that the embodiments and the accompanying drawings have been described for illustrative purposes and that the present invention is limited only by the claims.

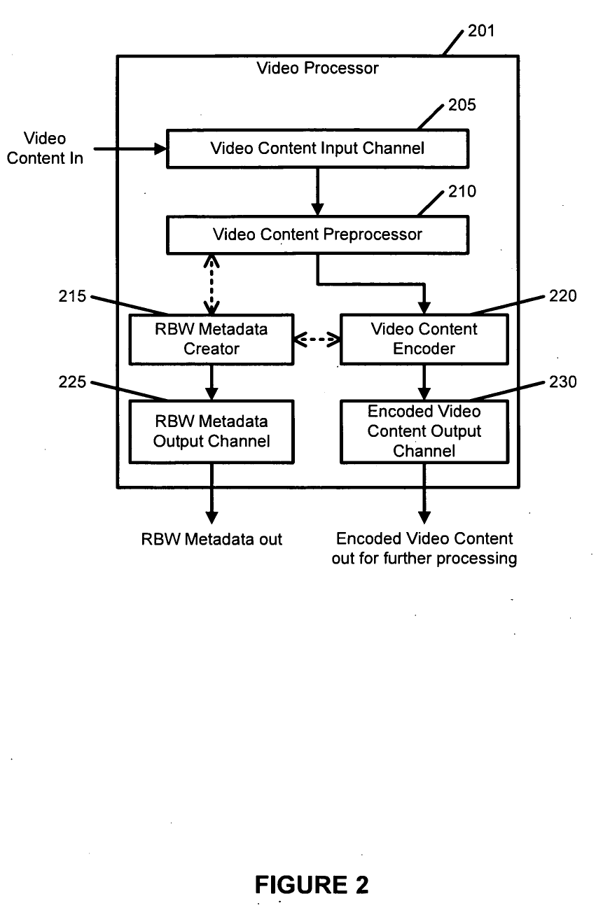

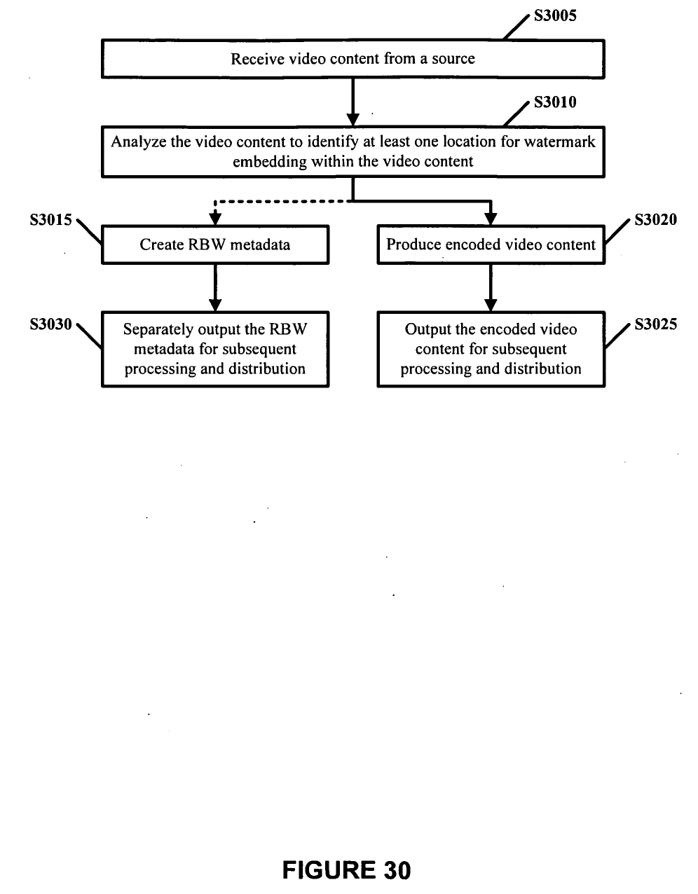

The present invention includes a novel video processor for forensic watermarking. Referring to FIGS. 2 and 30, the video processor 201 may include a video content input channel 205; a video content preprocessor 210; a replacement based watermarking (RBW) metadata creator 215; a video content encoder 220; an encoded video content output channel 225; and an RBW metadata output channel 230.

The video content input channel 205 may receive any video content (e.g., digital data stream) from a source S3005. It may also read one or more files of video content.

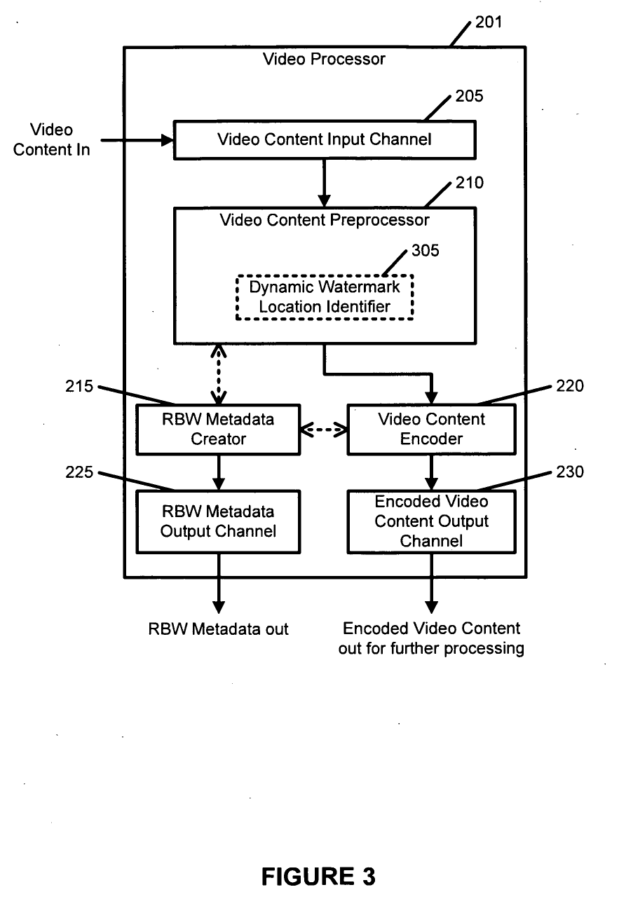

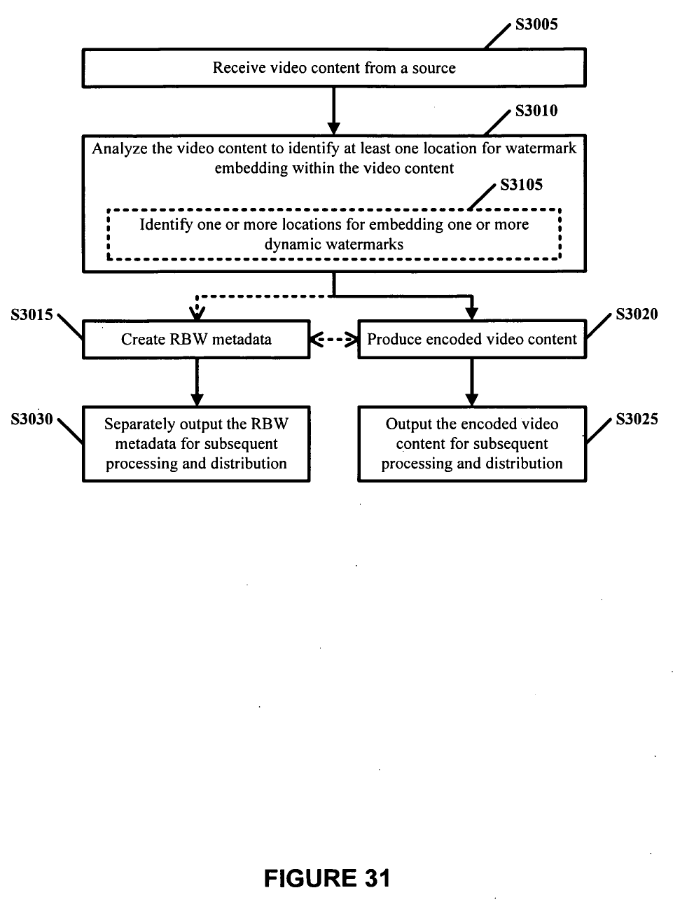

The video content preprocessor 210 is capable of analyzing video content to identify at least one location for watermark embedding within the video content S3010. It is an aspect of the present invention that watermarks can be embedded manually, automatically, openly, or blindly. Generally, the location can be a dynamic watermark location that is capable of being initialized with at least one dynamic watermark conveying a default message. The watermark initially placed in this location may, by design, be conditionally replaced by a downstream watermark inserter, with the purpose of substituting an application message for the default message. To aid identification, the video content preprocessor 210 may further include a dynamic watermark location identifier 305, as shown in FIG. 3. As the name of this component in FIG. 31 suggests, the dynamic watermark location identifier 305 identifies one or more locations for embedding one or more dynamic watermarks S3105. Dynamic watermarks are defined as watermarks that are designed to be altered in subsequent processing by substation of a fragment of the video content containing a different watermark with different semantic properties for the corresponding video fragment containing the original watermark.

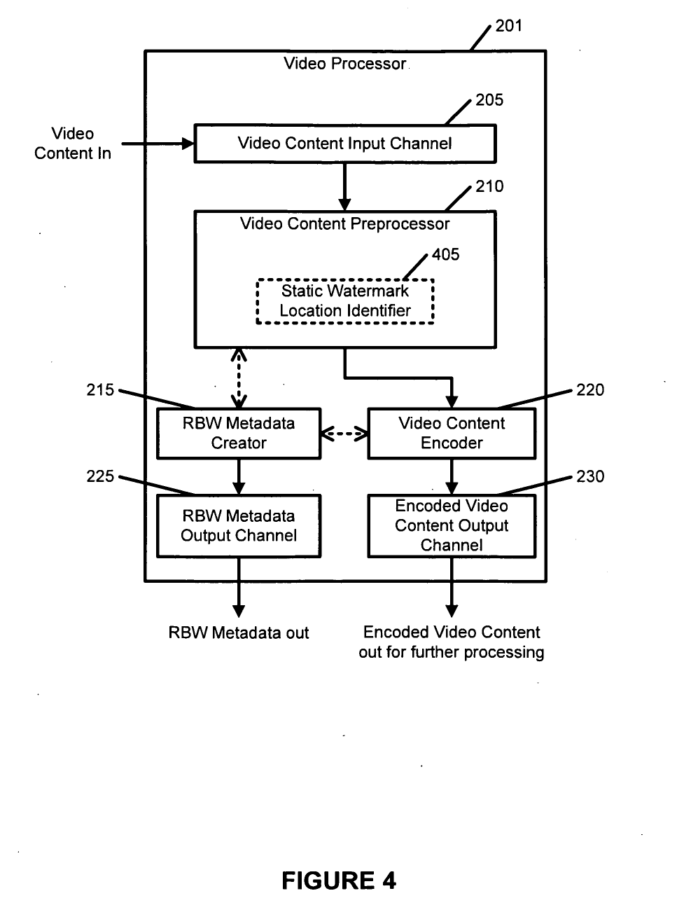

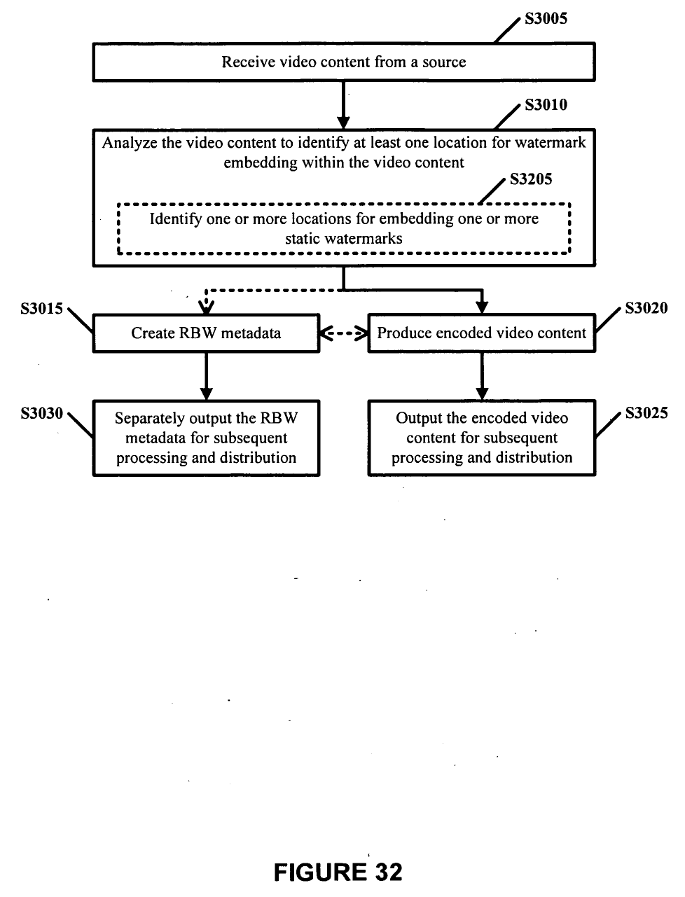

Alternatively, the location can be a static watermark location capable of being initialized with at least one static watermark. Static watermarks may convey information to assist in the recovery of the message conveyed by the dynamic watermarks. Just as above, the video content preprocessor 210 may further include a static watermark location identifier 405, as shown in FIG. 4. Referring to FIG. 32, the static watermark location identifier 405 is used to identify one or more locations for embedding one or more static watermarks S3205. Static watermarks are defined as watermarks (e.g., the commonly known ones) that are not intended to be altered after having been embedded or fixated onto content.

Hence, as an embodiment of the present invention, the watermark(s) for embedding within the video content may be at least one dynamic watermark, at least one static watermark, or any combination of the two types.

For watermark embedding to occur, the present invention uses RBW metadata. Generally, RBW metadata is any information that facilitates the embedding of watermarks into video content. RBW metadata may include at least one encoded watermarked video content fragment, suitably formatted to replace an identified segment of the encoded video content. As an alternative embodiment, RBW metadata may also include at least one watermarked video content fragment, suitably formatted to replace an identified segment of a baseband video, subsequent to decoding. As an additional alternative embodiment, RBW metadata may denote masking properties for at least one potential dynamic watermark location. Masking properties may inform a process that may create a watermark to be embedded in the potential dynamic watermark location.

To create RBW metadata S3015, an RBW metadata creator 215 is required. At least one watermark being embedded should represent at least part of the message. As an embodiment, the RBW metadata creator 215 can use a set of configuration parameters to control the procedures (in particular, algorithms) that determine the location and composition of watermarks contained in or controlled by the RBW metadata. For example, configuration parameters may specify tolerance for watermark visibility or required robustness, thereby affording the operator control over the visibility-robustness tradeoff.

Because the video content may not be encoded, it is desirable for the video processor 201 to include a video content encoder 220 that is capable of producing encoded video content S3020. The video content encoder 220 may be capable of conditioning the video content to facilitate the embedding of watermarked video fragments contained in the RBW metadata. Such conditioning is performed to permit specific segments of the encoded content to be replaced by the watermarked video fragments, all the while maintaining the validity of the encoded video. Meanwhile, it may also have the ability to avoid creating references to locations identified for the dynamic watermarks. By suppressing motion vectors referencing locations containing dynamic watermarks, the encoder avoids undesirable propagation of watermarks into other frames or locations with a frame. Furthermore, the video content encoder 220 has the ability to dynamically adjust parameters affecting compression. Such adjustments may be helpful to produce desired output bit-rates, particularly when utilizing in-frame RBW metadata.

The encoded video content output channel 225 may output the encoded video content for subsequent processing and distribution S3025. For example, the encoded video content may enter a set-top box containing a video decrypter, decoder, and renderer. It should be noted that the renderer is a component that is used for rendering and/or processing images and/or video content.

Similarly, the RBW metadata output channel 230 may separately output the RBW metadata for subsequent processing and distribution S3030. For example, the RBW metadata may enter a set-top box containing a video decrypter, decoder, and renderer.

Using this schematic design, the dual output channels of the video processor 201 allow both the RBW metadata and the encoded video content to be forwarded (e.g., delivered) in a separated data streams. The purpose of such design allows for the scenario where it is not desired to include the RBW metadata within the encoded video content. Separate delivery of RBW metadata may be necessary to successfully integrate RBW processing with certain content delivery architectures.

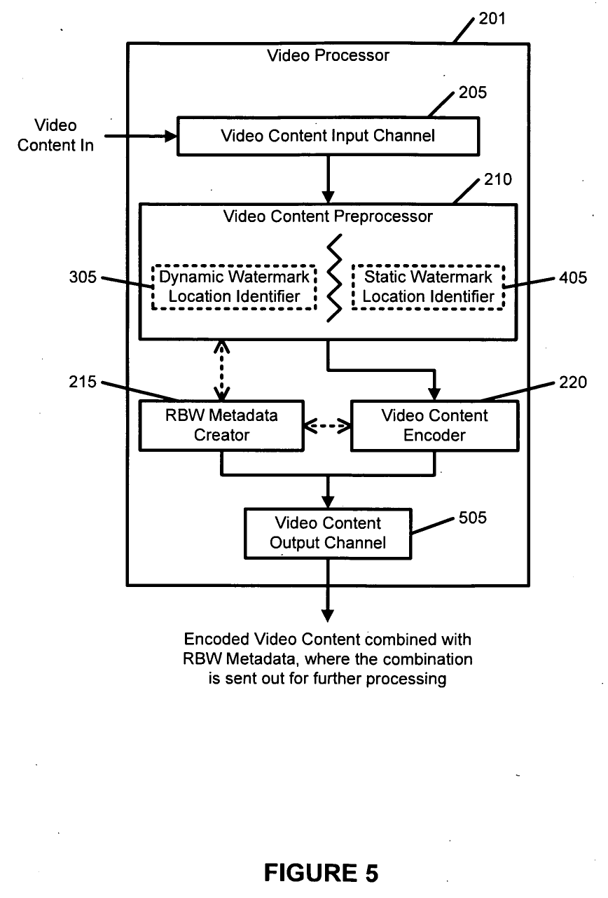

However, there may be times when it is desirable to have part or all of the RBW metadata to be distributed with the encoded video content simultaneously as a combined entity. Combining the RBW metadata with the video content affords transmission transparent to the delivery channel, and leverages the content protection mechanisms, such as encryption, to secure the RBW metadata. In such instances, a single output channel would be required. Where this scenario is true, then as another embodiment, the video processor 201, as depicted in FIG. 5, may comprise the following: a video content input channel 205; a video content preprocessor 210; an RBW metadata creator 215; a video content encoder 220; and a video content output channel 505. The zigzag line in video content preprocessor 210 denotes that the video content preprocessor 210 may either include the dynamic watermark location identifier 305, the static watermark location identifier 405, both, or neither.

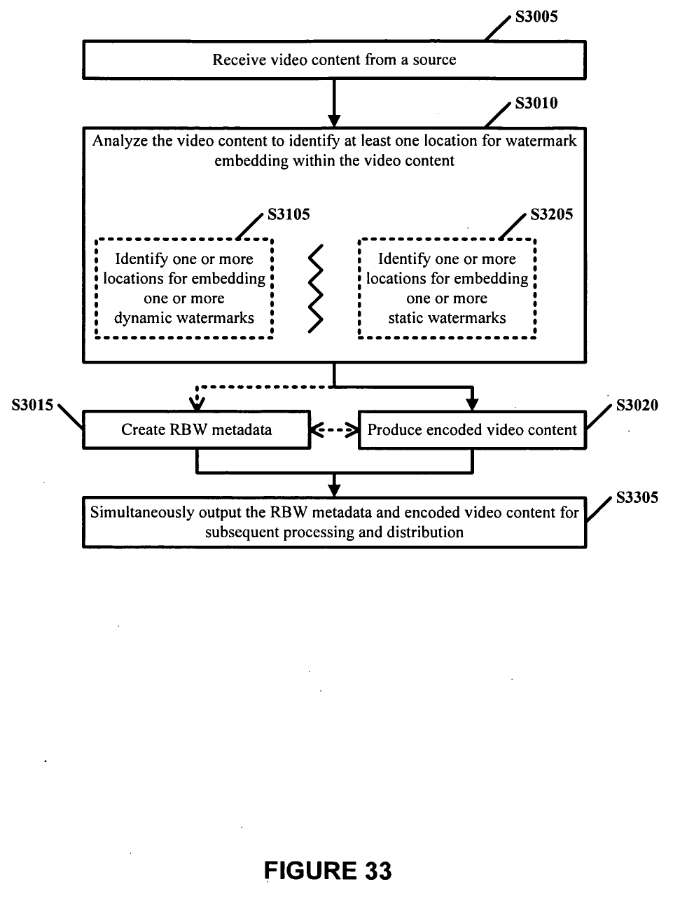

By having just one video content output channel, this embodiment allows for the RBW metadata and the encoded video content to be sent (e.g., delivered) simultaneously S3305, as shown in FIGS. 5 and 33. To be sent together, it may be necessary to package the RBW metadata with the encoded video content as a single package (using, e.g., a packager) for transport. As part of the package, the encoded video content may be combined with the RBW metadata.

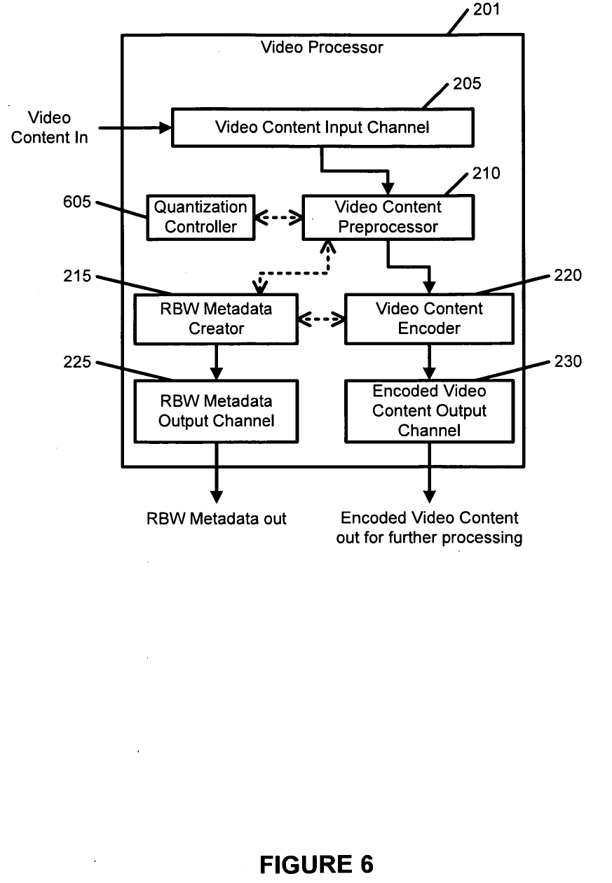

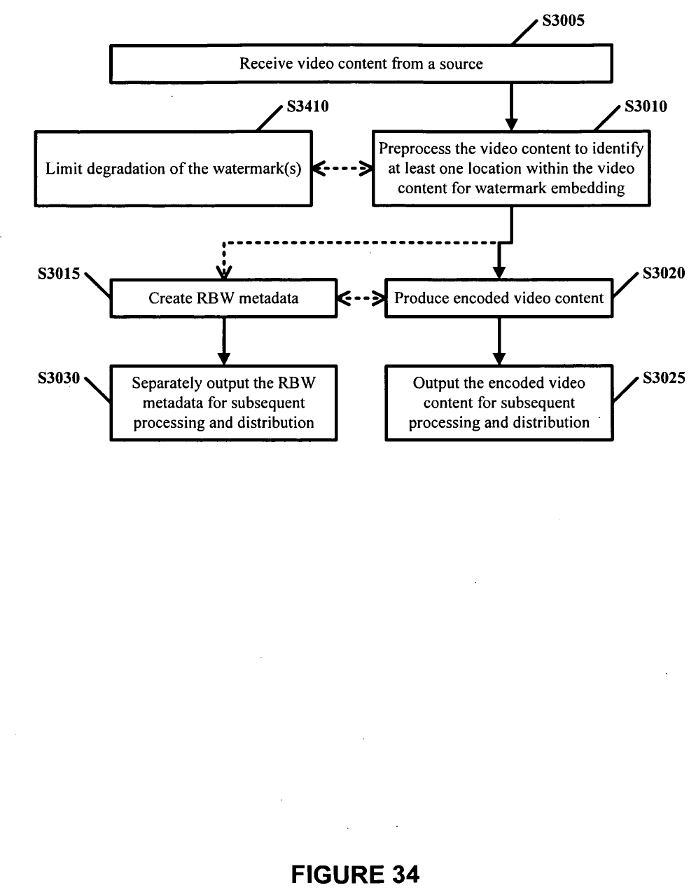

Because it is possible for watermarks to be degraded by the video encoder, a quantization controller 605, as shown in FIG. 6, may be added to the video processor 201. Such element can interact with the video content preprocessor 210 and be configured for limiting degradation of the watermark(s) (whether static and/or dynamic) S3405, as indicated in FIG. 34. For example, the quantization controller may selectively apply finer quantization to the watermarked region in order to preserve watermark fidelity, thereby enhancing robustness.

As another embodiment, the video processor 201 may employ a human visual system model. The HVS model may be employed to identify areas in the video where watermarks are less likely to be perceived, and to determine the permissible strength (amplitude) of the watermark signal, as constrained by video fidelity requirements.

It should be noted that whether the video processor 201 uses a dual or single video output channel, the present invention allows the video processor 201 to either be an integrated video processor or a nonintegrated video processor. The term “integrated” generally means a tight coupling between two or more separate entities. The term “nonintegrated” generally means the opposite of “integrated.”

V. Replacement Based Watermarking

An RBW system may be designed to incorporate the video processor described above. In one embodiment, the system may be designed in a way such that an RBW Inserter (also referred to herein as Inserter or RBW Insertion Module or RBW Inserter), which often resides in resource constrained devices, requires very little memory or CPU resources. The intelligence of the system may reside almost entirely at the Pre-Processing phase, which is responsible for decisions involving watermark location and substance.

U.S. Pat. No. 6,285,774, entitled “System and methodology for tracing to a source of unauthorized copying of prerecorded proprietary material, such as movies” describes how an encoded (compressed) media file may be processed to prepare for replacement based watermark insertion. This pre-processing is typically performed on packaged (e.g. DVD format) content and necessitates decoding and re-encoding of much of the content. Additionally, the results may be constrained by a requirement to retain the original packaging.

This paradigm has been useful in protecting DVD and theatrical content. However, extension into the broadcast, IPTV, and related channels creates the need for real-time replacement based watermark preparation. Additionally, the use of higher power codecs, such as those in the MPEG-4 family, may require a more complex preparation process. For these reasons, it becomes advantageous to integrate replacement based watermark preparation into the encoding process.

The following embodiment describes an enhanced realization of the RBW system suitable for use in the broadcast and IPTV channels.

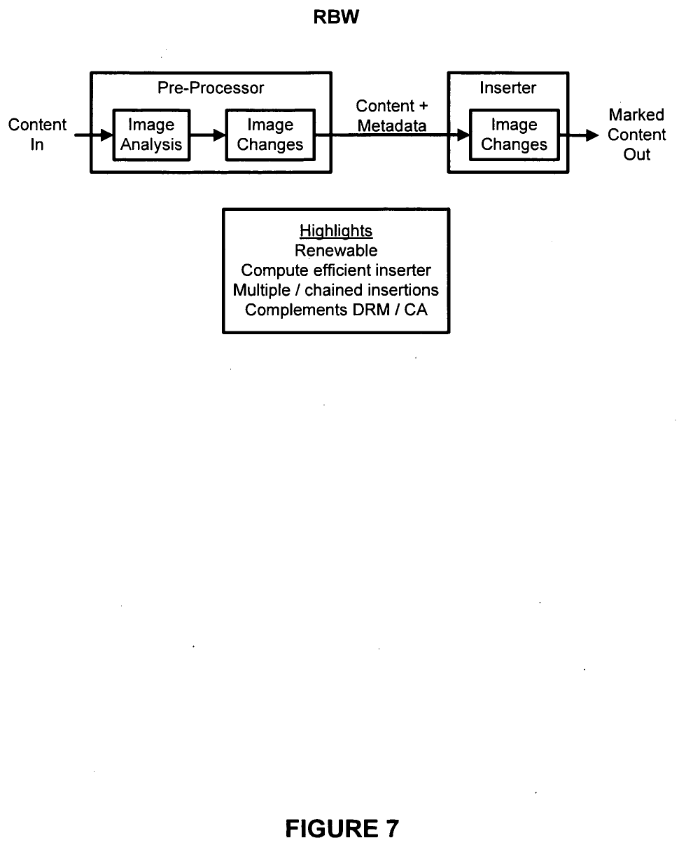

Referring to FIG. 7, a simplified RBW architecture that can be implemented within the video processor 201 involves an analysis component that is separated from and independent of the Inserter. The Inserter is the component that performs the processing specific to the message, including, but not limited to, the embedding of the message into the content. At the time analysis is performed, the message has not yet been determined. In general, analysis occurs in the pre-processing stage. When content enters a Pre-Processor component (e.g., video content preprocessor 210), images may be analyzed and/or changed. For any image analyzed or created, the RBW metadata creator 215 may create a set of metadata for that image. This metadata set may then be conveyed with the content to an Inserter. In turn, the Inserter may selectively replace fragments of the content stream using watermarked content fragments from the metadata, such that the watermarks in the resulting content stream convey the message.

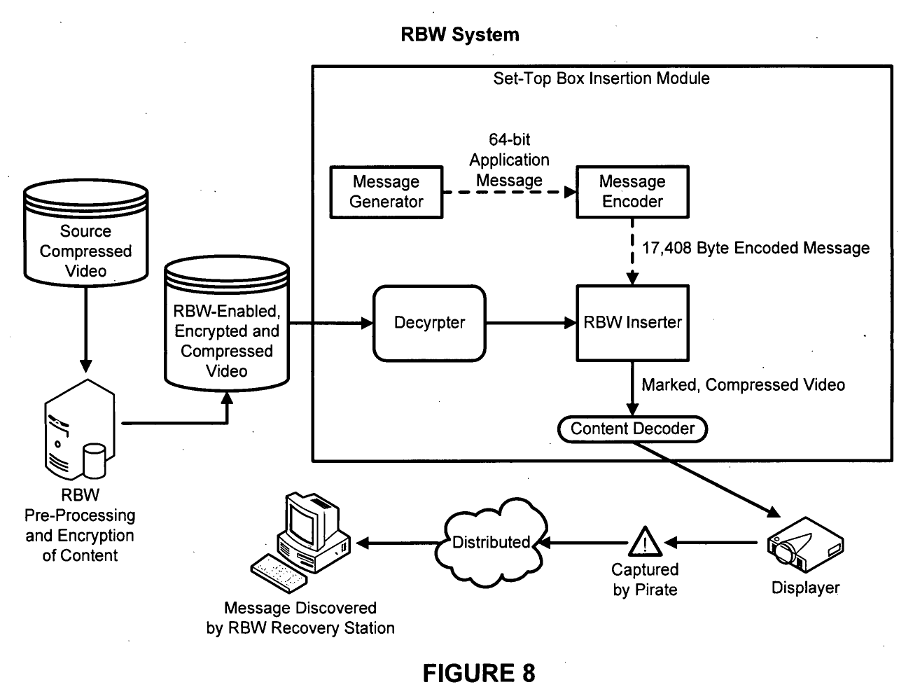

As illustrated in FIG. 8, the RBW system may utilize encryption to protect the content and metadata in the distribution channel. In this embodiment, the result of the pre-processing (analysis and encoding) phase is encrypted prior to its release into the distribution channels. The receiver of the content contains a decryptor, which restores the content and metadata to its plain text format for use by the RBW Inserter and the content decoder.

This RBW-enabled, encrypted and compressed content may be forwarded to an RBW-enabled device (e.g., a Set-Top Box). The device may have a multitude of components, including a message generator, a message encoder, a decrypter, an RBW Insertion Module and a video decoder. The decrypter may receive and decrypt the RBW-enabled, encrypted and compressed content. After decryption, the decrypted content may be forwarded to the RBW Insertion Module. There, the RBW Insertion Module may embed watermarked content representing an Encoded Message that was generated by the Message Generator and encoded by the Message Encoder. The product, which should be marked compressed video, may then be forwarded to a video decoder. When the marked compressed video is transferred to a renderer and the content is displayed, pirated and distributed, the message may be discovered by an RBW Recovery Station. It is this discovery that can lead to the identification and potential capture of the pirate.

The RBW architecture provides numerous advantages. One, the Inserter may be agnostic to the algorithms used in the Pre-Processor. This characteristic may allow the renewal of the watermarking method without modification to any Inserter in the field. Two, the Inserter may require minimal computational and memory resources since all the resource intensive analysis is performed in the Pre-Processor. This characteristic may allow the Inserter to be economically feasible across the range of playback devices supported by a system operator. Three, the pre-processing may be performed once, prior to distribution (although some embodiments may also provide for multiple pre-processors). Additionally, multiple insertions can occur as the content flows through the distribution and playback chain. Four, the RBW system may work in the compressed domain, thus allowing the Inserter to reside inside the secure envelope of the DRM/CA modules.

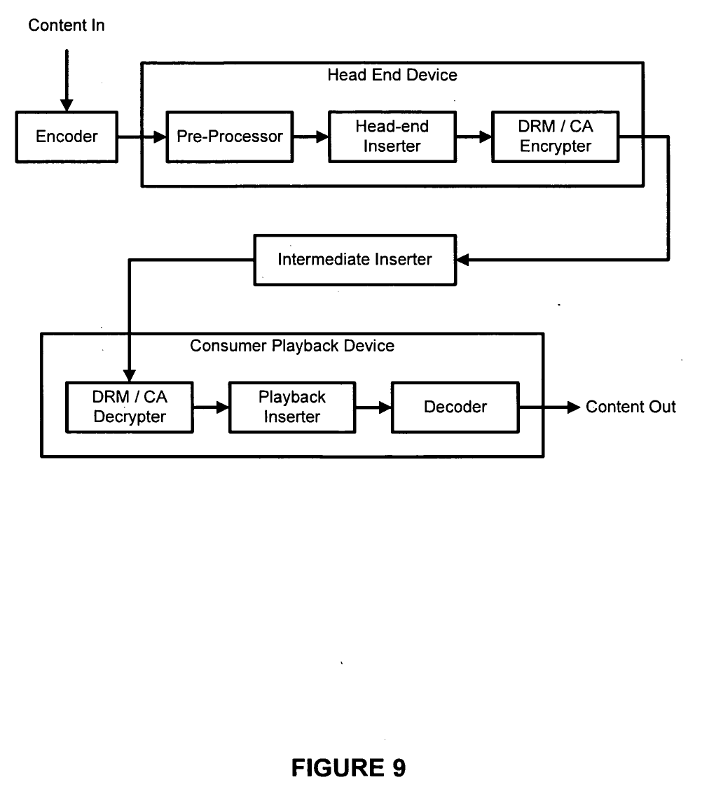

For consumer applications, such as a consumer video distribution system in conjunction with a DRM and/or CA system, RBW may be implemented using the general model as illustrated in FIG. 9. Here, the Encoder may receive content, encode it, and pass it onto a Head End Device. The Head End Device may include a Pre-Processor, a Head-end Inserter and a DRM/CA Encrypter. After having been analyzed and processed in the Head End Device, content may then be passed on to an Intermediate Inserter of a distribution system. From the Intermediate Inserter, the content may be passed on to the Consumer Playback Device. The Consumer Playback Device may include a DRM/CA Decrypter, a Playback Inserter, and a Decoder.

RBW may be used with any audio and/or video compression system (e.g., all MPEG formats).

The RBW system may encompass three major basic phases. These are the RBW Pre-Processing, RBW Insertion and RBW Recovery. RBW Pre-Processing may include an RBW Pre-Processor. RBW Insertion may include at least one message Inserter. RBW Recovery may include an RBW Recovery component. Each is further discussed in more detail below.

A. RBW Pre-Processing

Several RBW Pre-Processing methods may be used, including preparation for source-based (informed) message recovery and “blind” (no source reference) recovery. The method used affects the amount of RBW metadata produced by pre-processing, typically ranging in size from about 1% to about 3% of the original content. This metadata may be conveyed in-frame (in the video elementary stream) or out-of-frame, depending on the specific application requirements.

RBW Pre-Processing may be CODEC-specific since analysis may be done in the compressed domain and the output stream, including metadata, must be compliant with that particular compression scheme.

For consumer video distribution applications, RBW Pre-Processing may be accomplished prior to encrypting content for loading onto a VOD server, loading onto a “download and burn” server, or distribution in real time in the head-end in the case of watermarking live broadcast content.

RBW Pre-Processing embodiments may exhibit several notable architectural features. For example, RBW Pre-Processing can be integrated with a host application via an Application Program Interface (API). In such case, the RBW Pre-Processing API library may be linked with a host application. All interactions with the Pre-Processing task may then be handled via the API. In a potential API embodiment, the host application may present a video frame, along with its frequency domain transform, and be returned with a potential dynamic watermark location, along with an RBW metadata object to facilitate the watermark embedding.

Another architectural feature is the separation of RBW video algorithms from host code. These algorithms are often agnostic to transport format. RBW Pre-Processing can also be used either for pre-multiplexing or post-multiplexing. Additionally, it tends to support MPEG-2 SD, along with common interfaces with upcoming H.264 releases. Furthermore, it can process content one time for unlimited insertions by target devices. Moreover, it can insert an initial message in the pre-processed content.

1. RBW Pre-Processor

To accomplish RBW Pre-Processing, an RBW Pre-Processor may be used. Generally, the RBW Pre-Processor serves as the component that prepares content for message insertion in a number of different environments, including store-and-deliver (e.g., VOD), broadcast, at preauthoring or postauthoring, etc. The described architecture may support both Blind and Source-Based (informed) recovery models.

In addition, the RBW Pre-Processor may be provided as an API into an object library. The input may be an un-encrypted compressed stream. At the pre-processing stage, the RBW Pre-Processor may modify and condition the content to receive replacement based watermarks. The output generated by the RBW Pre-Processor may comprise of the modified compressed stream plus an RBW metadata element (carrier). Information in the RBW metadata element facilitates subsequent conditional replacement at a specific location in the video content by modifying the content to contain a specific watermark.

2. RBW Pre-Processor API

The RBW Pre-Processor API (also referred to herein as RMP_API) manages control and communication with the RBW Pre-processor task. The RMP_API may be used to instantiate an instance of the RBW Pre-Processor for processing a single content stream. Each instance may be controlled by an individual handle, allowing a single host application to process multiple content streams.

The RMP_API may be designed to minimize the number of content buffer copies while allowing the RBW Pre-Preprocessing engine to run as a separate process. The data may be transferred between the RBW Pre-Processor and host application using shared memory. To accomplish this task, RMP_API may use any model, such as the /dev/shm/ model.

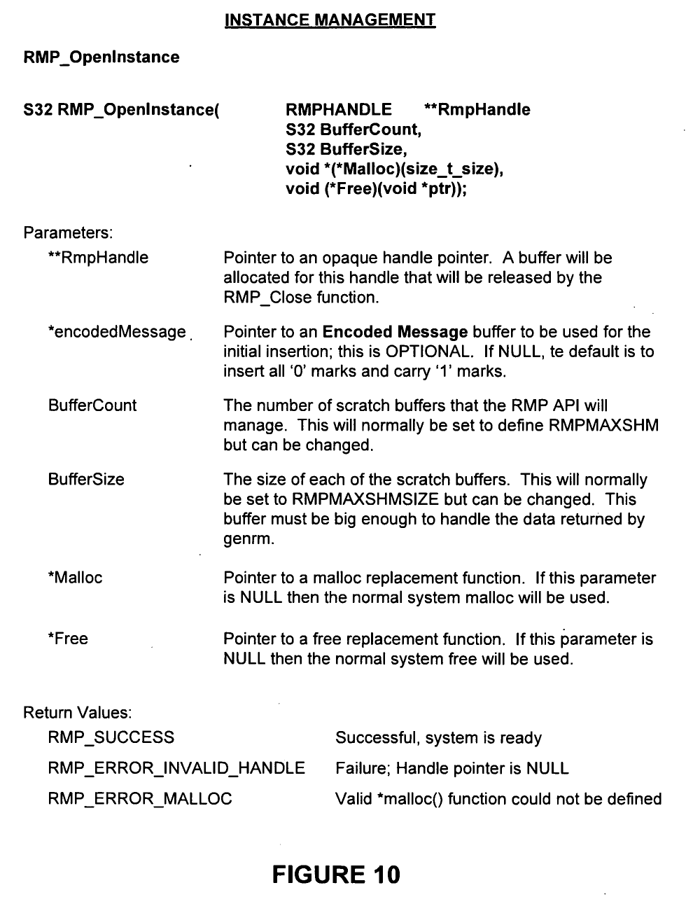

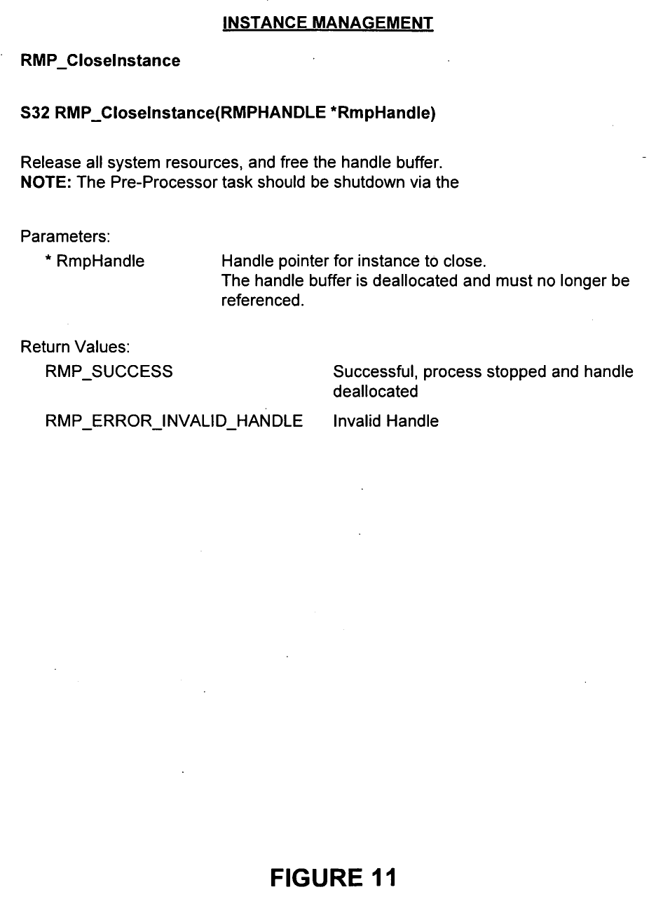

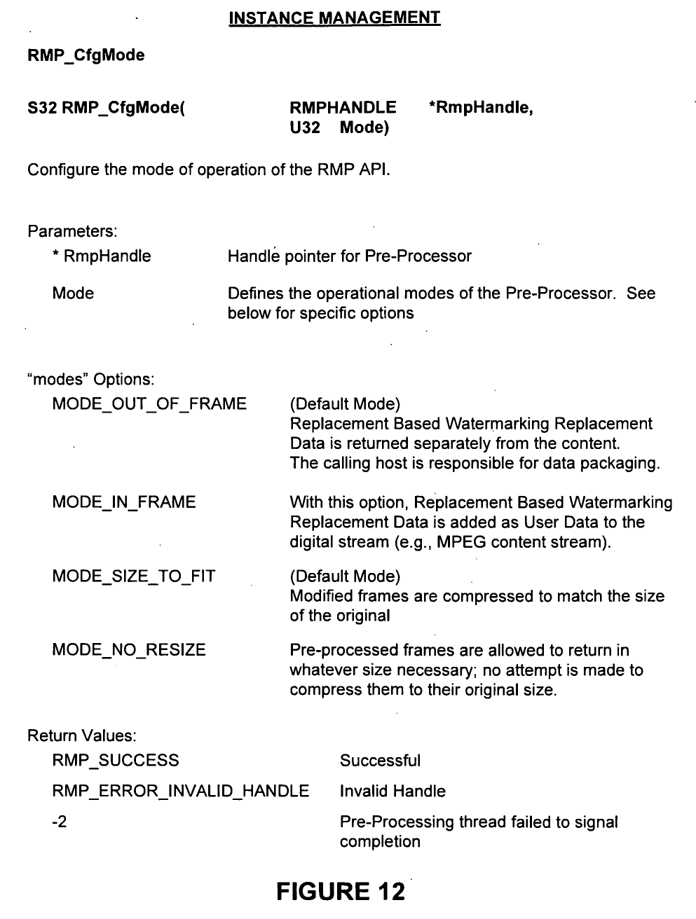

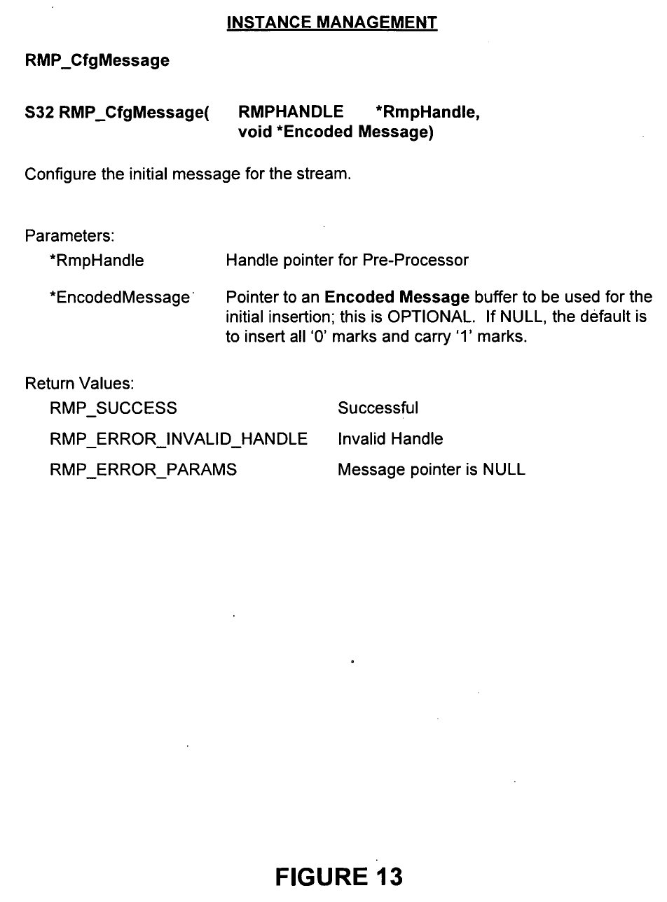

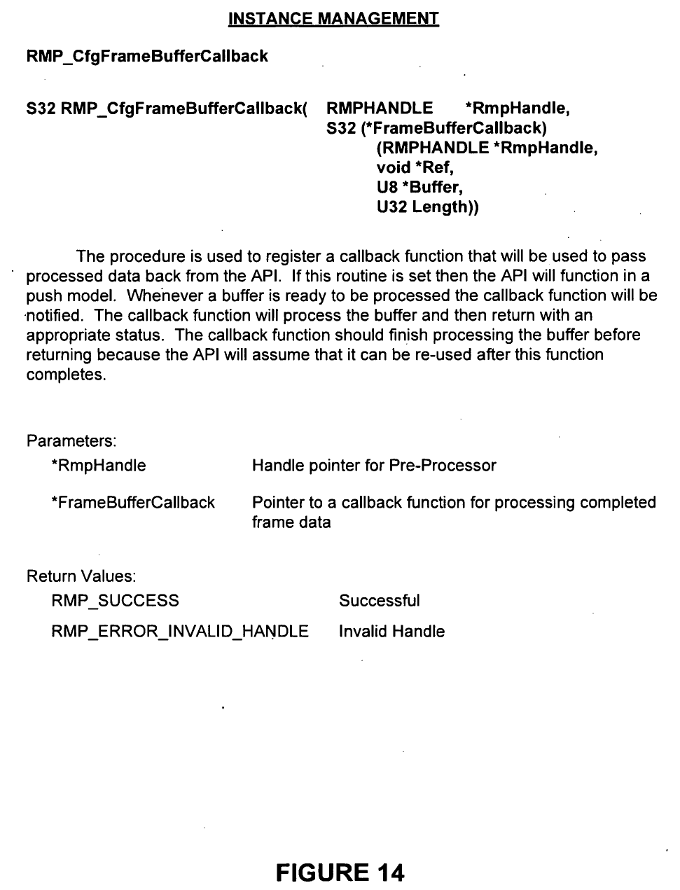

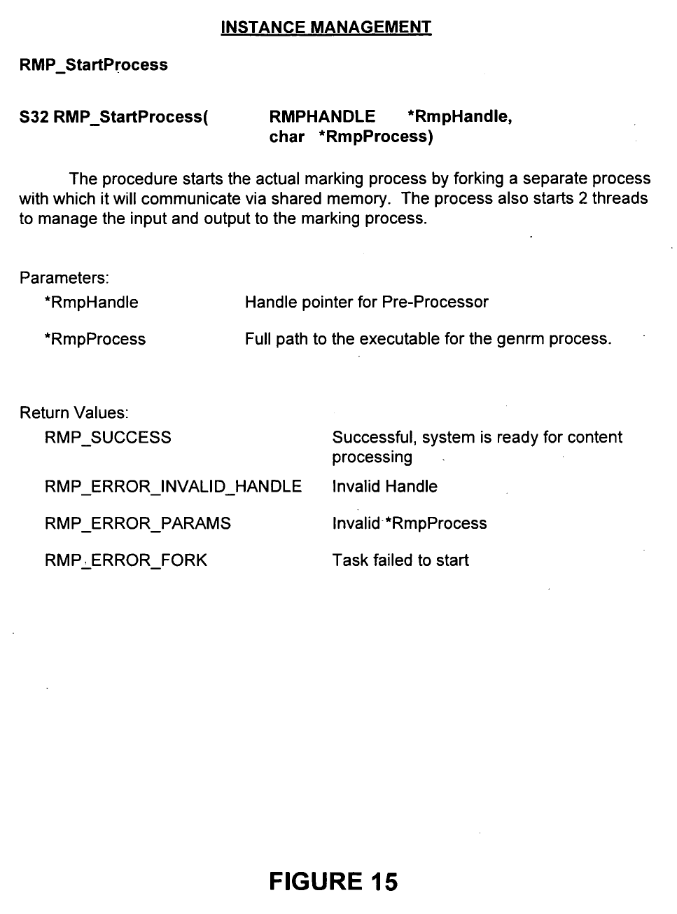

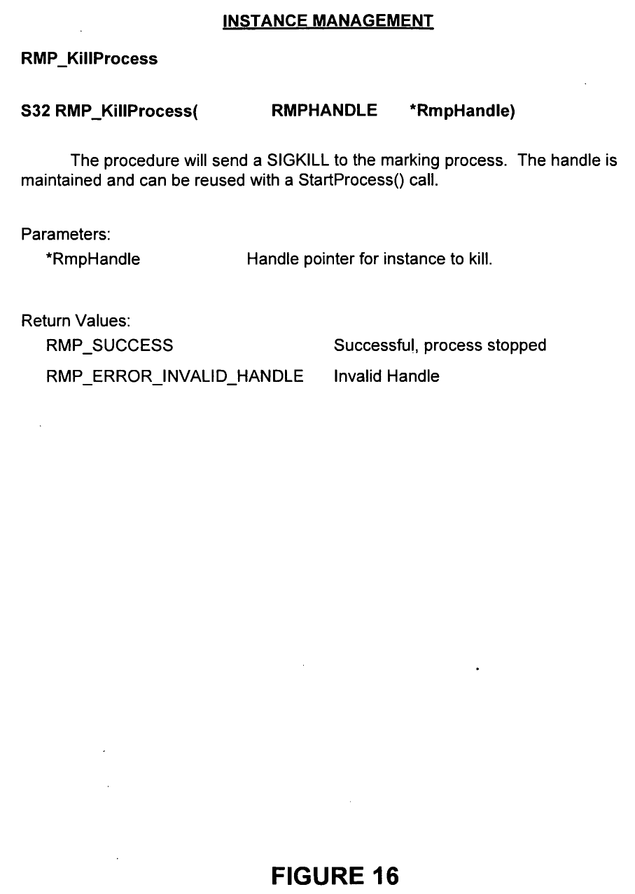

Fundamentally, the interface of the RBW Pre-Processor API may comprise of four main categories: Instance Management, Data Processing, Output Data Structure, and Code. The Instance Management category generally describes how multiple Pre-Processor instances may be managed by the system. It may comprise of seven components, including RMP_OpenInstance, RMP_CloseInstance, RMP_CfgMode, RMP_CfgMessage, RMP_CfgFrameBufferCallback, RMP_StartProcess and RMP_KillProcess. Respectively, FIGS. 10-16 highlight parameters and return values for each of these components.

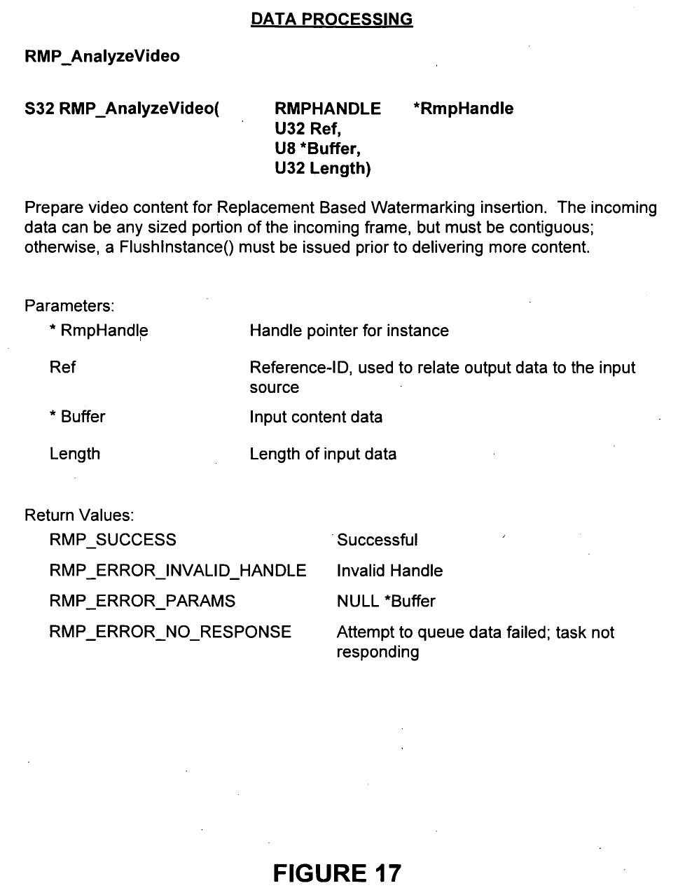

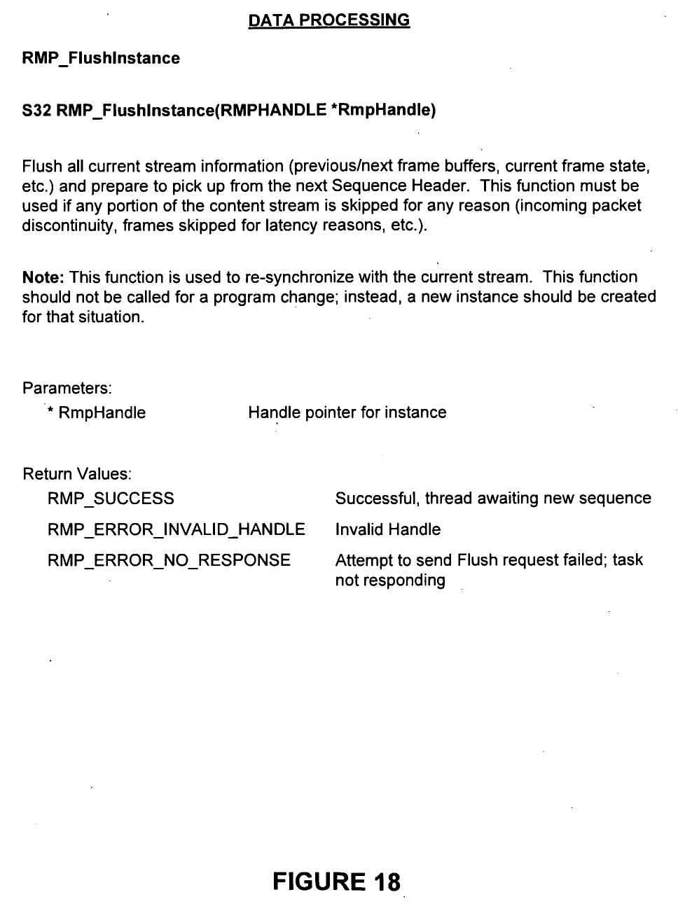

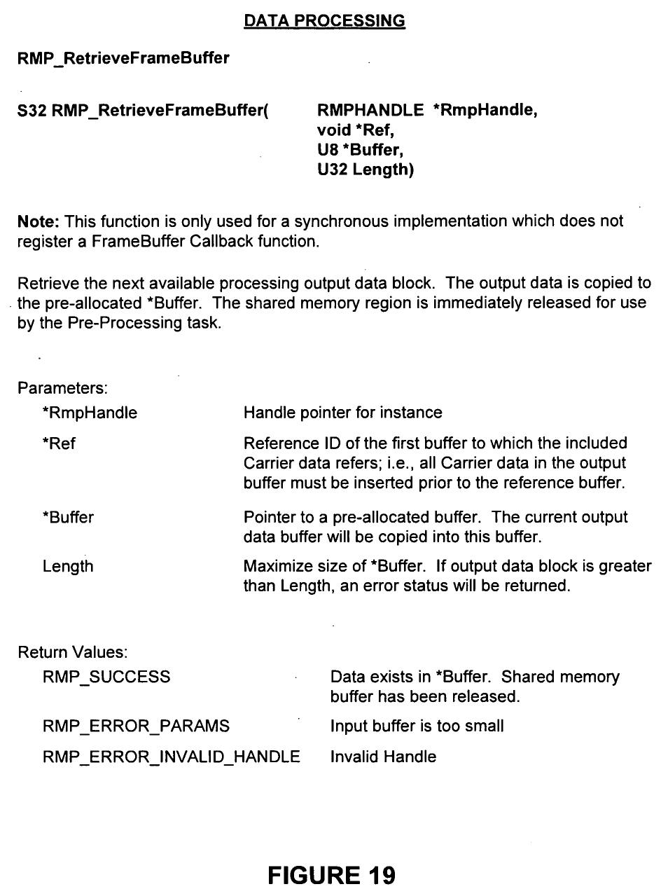

The Data Processing category generally describes how the content can be processed by the system. It may comprise of three components, including RMP_AnalyzeVideo, RMP_FlushInstance, and RMP_RetrieveFrameBuffer. Respectively, FIGS. 17-19 highlight parameters and return values for each of the components.

In Output Data Structure category generally describes the disposition of the resulted RBW enabled content. The output data from the Pre-Processor may be placed in a circular queue of shared memory buffers. Each output buffer may contain all data associated with a single watermarked frame. The output has two main components: the reconstructed frame and its associated Carrier data. If In-Frame Carriers are used, the Carrier data portion should be empty.

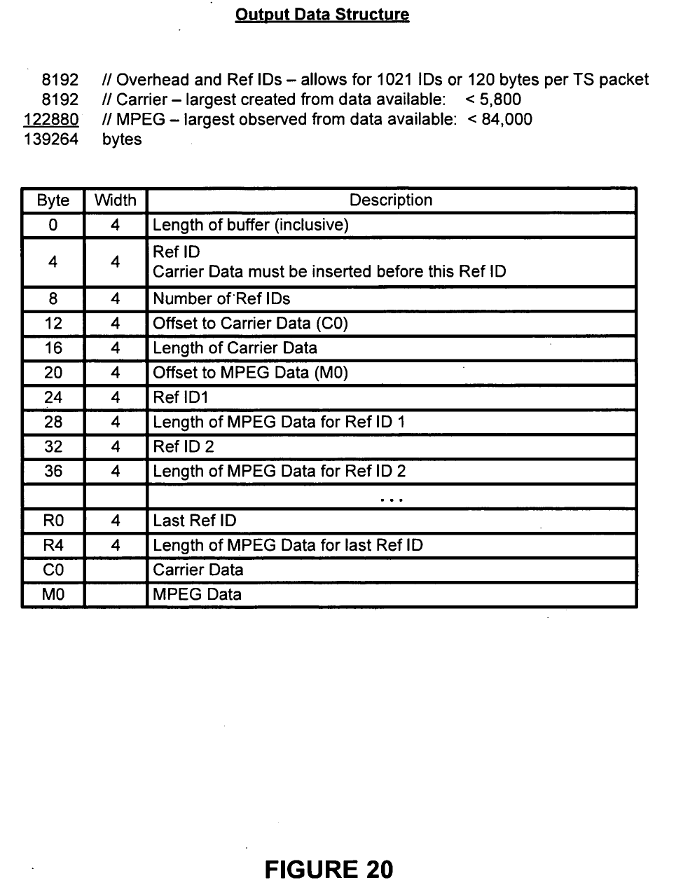

A list of Reference IDs and lengths are typically given so that the application can associate the reconstructed frame data with the original input buffers. The total size of the output buffer is configurable to the specific application. For instance, the sizes listed in FIG. 20 indicate a standard definition for MPEG-2 content.

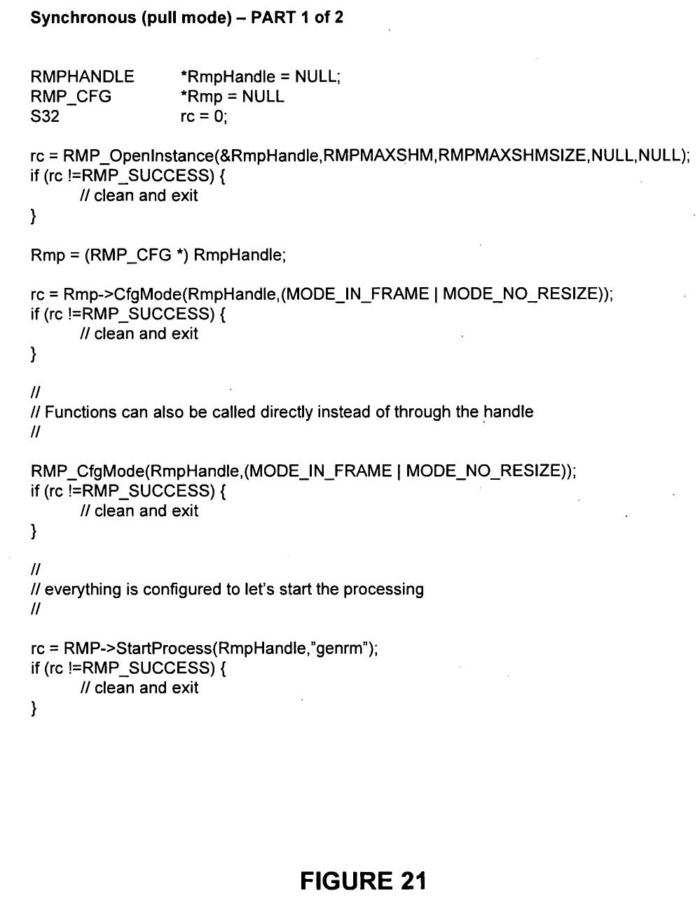

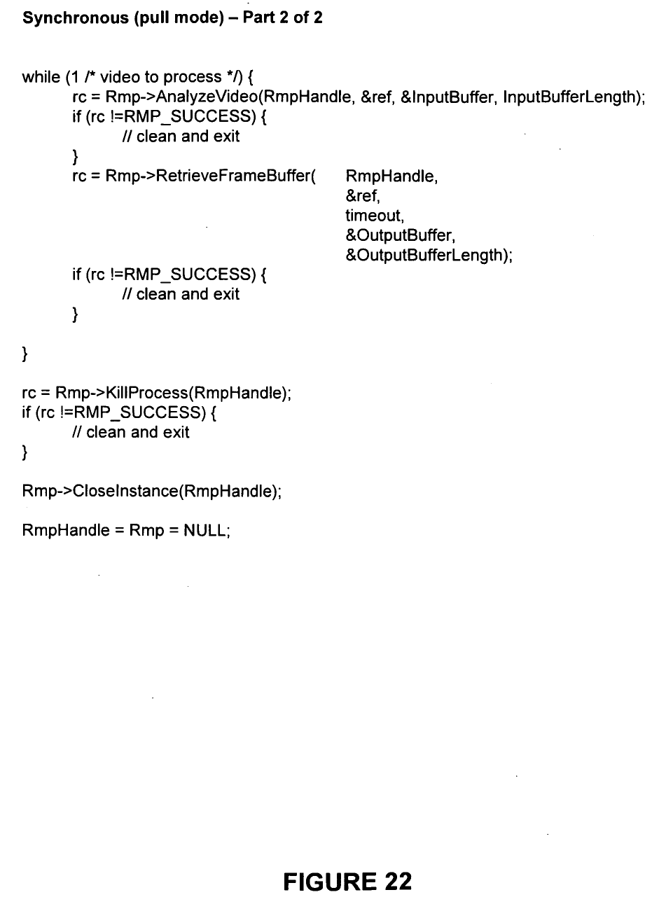

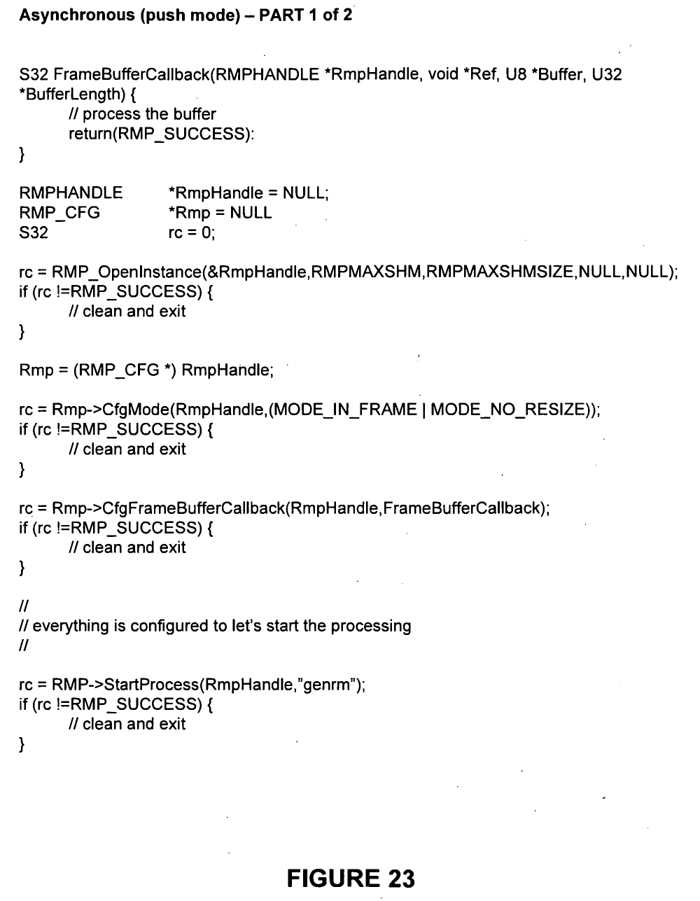

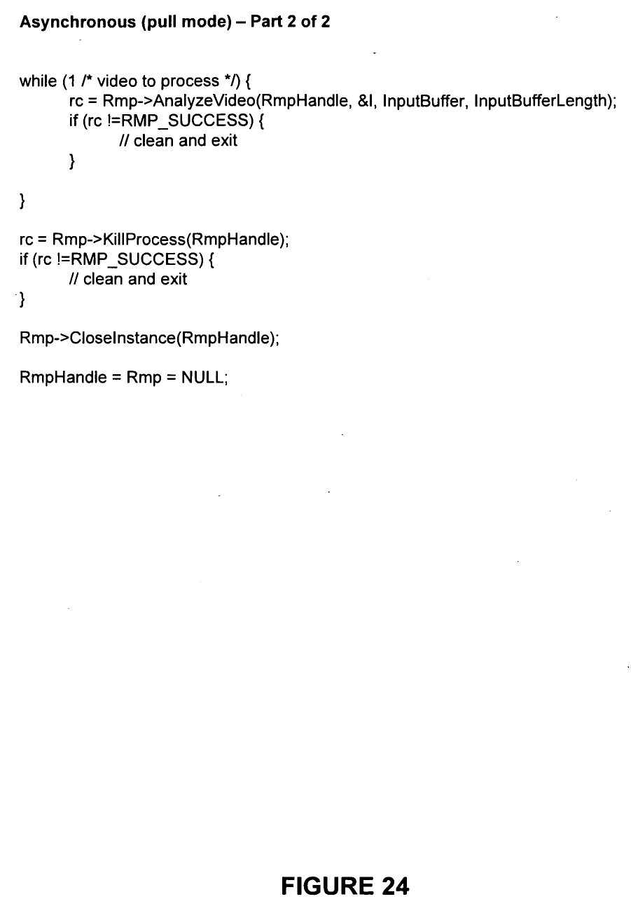

The Code category may embrace a multitude of data flow models that may be utilized in the RM_PreProcessing stage. Modes of operation that the RMP_API may support include synchronous (pull mode) and asynchronous (push mode). The asynchronous mode may be more efficient, as the synchronous models may require an extra data copy. FIGS. 21-22 show an example of a synchronous (pull mode) code. FIGS. 23-24 shows an example of an asynchronous (push mode) code.

3. RBW Carrier Packaging

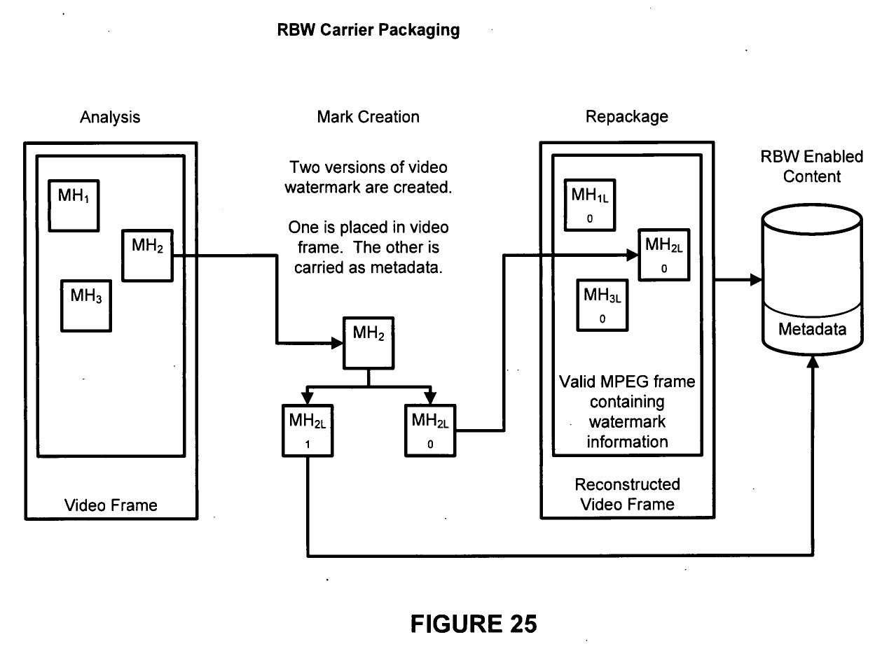

The result of RBW Pre-Processing may be a reconstructed video frame and a group of replacement blocks, which may be included in metadata. Phases of RBW Carrier Packaging in the RBW Pre-Processing stage are shown in FIG. 25.

Averaging about 1-3% of the content stream, metadata may be carried in a number of ways to support various pre-processing environments and transport formats. To maintain flexibility with transport systems, the RBW Pre-Processor is capable of packaging RBW metadata as In-Frame or Out-of-Frame Carriers.

In the In-Frame Carrier model, the RBW Replacement Data may be embedded as User-Data (as described in the relevant codec specification) into the encoded video frame to which it pertains. It may be placed (e.g., in a User Data block) just prior to the first slice start-code of the frame (or picture). This method is intended primarily for pre-mux operation on elementary streams, as the resulting video content should be slightly larger than the original.

Several advantages may arise from using the In-Frame model. One, no more additional data streams may be need to be processed. Carriers appear as a portion of the encoded picture and tend not to be subject to being moved by re-muxing processes. Two, impacts on buffering requirements are minimal. Each frame contains only the Carrier data required for that frame. Three, this model leverages the content protection native to the distribution system; carriers are encrypted along with the video content.

The Out-of-Frame Carrier model may, however, be more appropriate in a post-mux environment where the content must remain in its original packaging. In this case, RBW Replacement Data is returned in an independent data structure, thereby not affecting the size or bit-rate of the original content. Out-of-Frame RBW Replacement Data may also be packaged as a separate private data stream in the transport or storage protocol.

4. Application Integration

Several integration models may be applied to the RBW Pre-Processor in various environments. It should be noted that not all possible use models can be described here. However, the intent is to explain some possibilities to illustrate the flexibility of the system.

There are a few general points to keep in mind. One, input data can be video elementary data or uncompressed YUV data. If the data to be processed is packaged in a transport format, it is the responsibility of the host application to provide pointers to the data elements to allow the RBW Pre-Processor to remain transport agnostic.

Two, input to the RBW Pre-Processing system should not need to be aligned to any logical border (packets, frames, etc.). The system should work on data as it arrives in any size packet.

Three, the input data may be buffered. Processing of a data buffer is generally not complete when the data queuing function has returned.

Four, the system can be used in either a synchronous (data pull model) or asynchronous (data push model) fashion. However, the synchronous model may require an extra data copy of processed frames.

Five, the system may only return those buffers which have been modified. Input buffers tend to be tracked by a unique Reference-ID, which are reported in the output data. Such tracking helps allow the output data to be matched to its original input buffer.

a. Elementary Stream Video with In-Frame Carriers

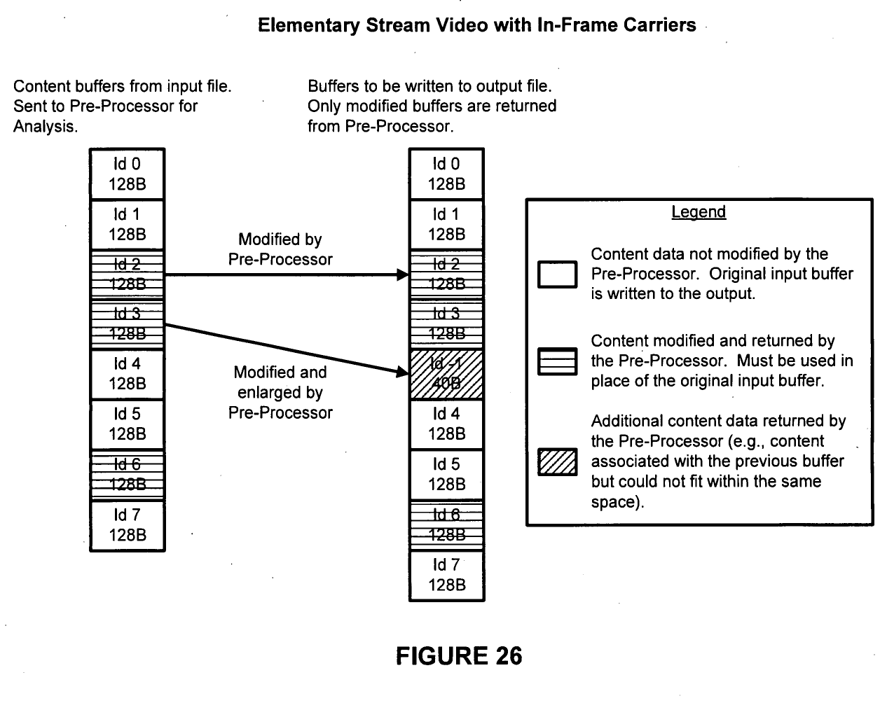

As shown in FIG. 26, an example of an integration model is elementary stream video with In-Frame Carriers. This example is a typical pre-authoring/pre-muxing application. The elementary video assets may be pre-processed for replacement based watermarks. They may then be packaged into their intended transport or storage format. It should be noted that the resulting elementary stream may be larger and have a slightly higher bit rate than the original, as the RBW Replacement Data is carried as part of the video frame data.

b. Transport Stream with Out-of-Frame Carriers

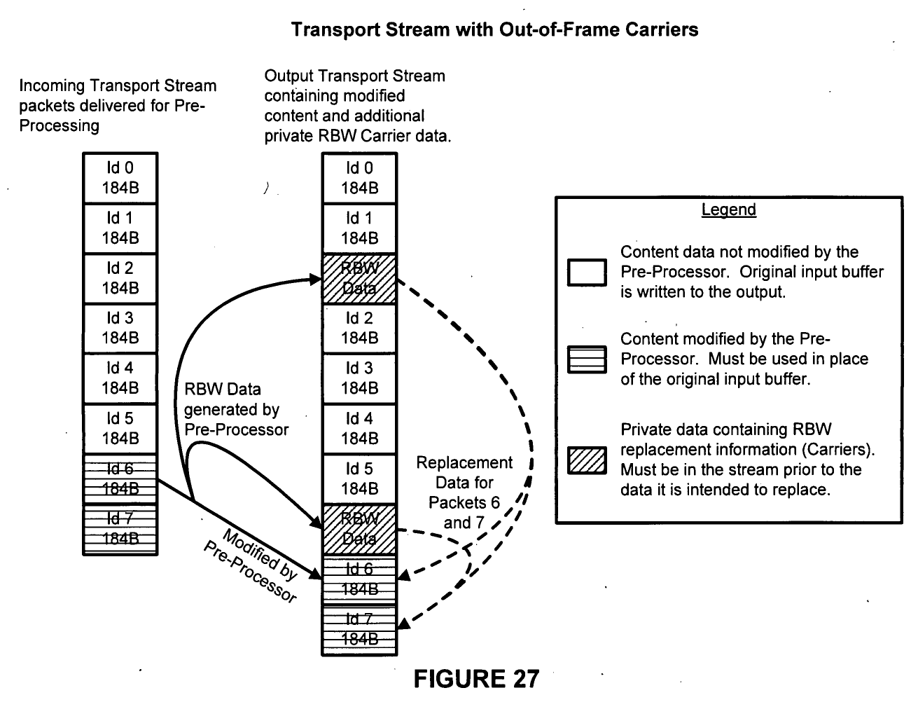

FIG. 27 shows another example of an integration model. This example is a transport stream model with Out-of-Frame Carriers. It may be assumed that the incoming content stream is already muxed. Therefore, Pre-Processing is not allowed to alter the size of the video frames. While it might be possible to put In-Frame Carriers in the video and reconstruct the video frame back to the original size, in most applications such an operation would involve unacceptable visual quality degradation.

As an alternative, the Carrier data may be stored and transported in a private data stream. While the specifics of the implementation are dependent on the transport protocol being used, the operation of the RBW Pre-Processor should be generic.

The output of the RBW Pre-Processor may contain two blocks of data: the reconstructed frame and the Carrier data. The reconstructed frame may be of the same size as the original input, and can therefore be returned to the original input buffers. The Carrier data may be packaged into a private data stream, and delivered in such a way that it arrives at the Inserter prior to the video content to which it relates (e.g., the content which it may replace as a result of the insertion).

The Inserter may be required to buffer the Carriers until the related video content arrives. To fix the buffer requirements, each system implementation should adhere to a buffering model which constrains the volume of RBW metadata and the permissible delay between receipt of the Carrier and the specific video content to which the Carrier applies.

B. Replacement Based Watermarking Insertion Module

Another portion of the RBW system is the RBW Insertion Module. A purpose of the RBW Insertion Module is to modify the video channel of a piece of content to embed an Application Message that is recoverable by an RBW Recovery system. The RBW Insertion Module may comprise two source code libraries: a Message Encoder and a Replacement Based Watermarking Inserter.

1. Application Message Format

The Application Message is intended to identify the source of marked content. The Application Message may be selected by the RBW Inserter's host device, and may be recovered by the RBW Recovery system.

The Application Message may comprise of 64-bits of data. The first three bits may be reserved as a format identifier and may be assigned when a message format has been determined. Hence, 61-bits may be left for the message payload, as illustrated in TABLE 1, where the Message-Types are bits 63 . . . 60 of the 64-bit message (0-based).

TABLE 1
Example of Application Message

| | | | | | | | | |
|---|---|---|---|---|---|---|---|---|
| 63 . . . 61 | 60 . . . 56 | 55 . . . 48 | 47 . . . 40 | 39 . . . 32 | 31 . . . 24 | 23 . . . 16 | 15 . . . 8 | 7 . . . 0 |

| | |
|---|---|
| Message | Message Data Bits |
| Type | |

The following tables show examples of message formats that may be considered.

TABLE 2
Example of Device-ID Only Application Message Format
Device-ID Message Format

| | | |
|---|---|---|
| 63 . . . 61 | Message Type | (assigned) |
| 60 . . . 48 | Device Class | A class of devices, perhaps by manufacturer, |
| | | model, etc. |
| 47 . . . 0 | Device ID | A unique identifier of a specific Inserter |
| | | device. |

TABLE 3
Example of Device and Time Application Message Format
Device and Time Message Format

| | | |
|---|---|---|
| 63 . . . 61 | Message Type | (assigned) |
| 60 . . . 56 | Device Class | A class of devices, perhaps by manufacturer, |
| | | model, etc. |
| 55 . . . 24 | Device ID | Unique id of the playback unit. |
| 23 . . . 0 | Time | A time field approximating when the content |
| | | was decoded by the Inserting device. With |
| | | 24 bits to use, the time may be represented |
| | | as the number of minutes from an epoch |
| | | such as 12:00:00 AM, 1/1/2000. |

2. Message Encoder

The Message Encoder (also referred to herein as Message Encoding API) may transform the Application Message into an Encoded Message. The Encoded Message may represent the original Application Message with the addition of error-control coding.

For portability, the Message Encoding API should perform no memory allocation, as such task should be left for the host. A Message Encoding API may be provided to determine the length of the buffer necessary for the Encoded Message.

The Message Encoding API may accept the following: a pointer to the Application Message, a pointer to the buffer to hold the Encoded Message and a random seed variable. The host should provide a random number or time value for the seed. The seed value should not be constant.

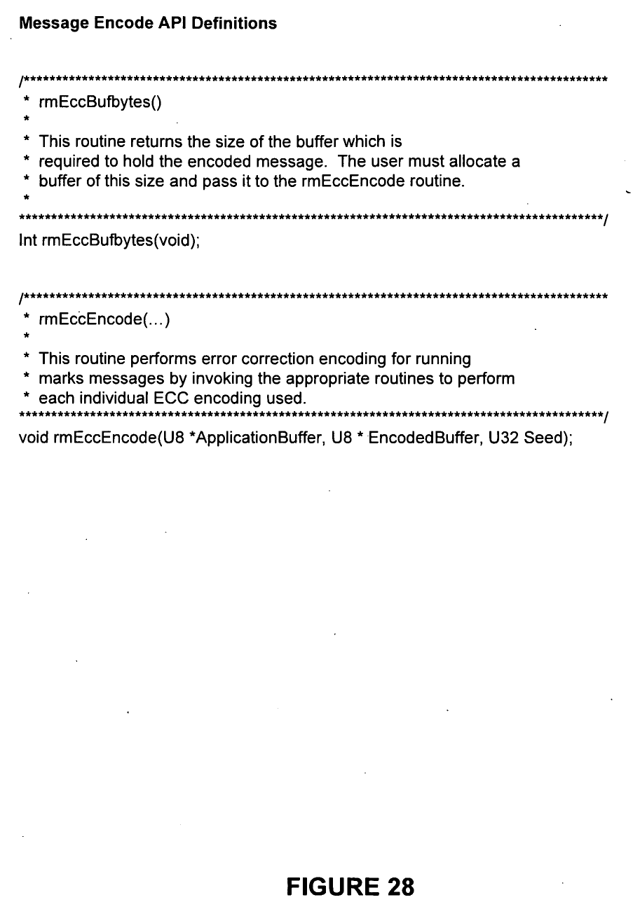

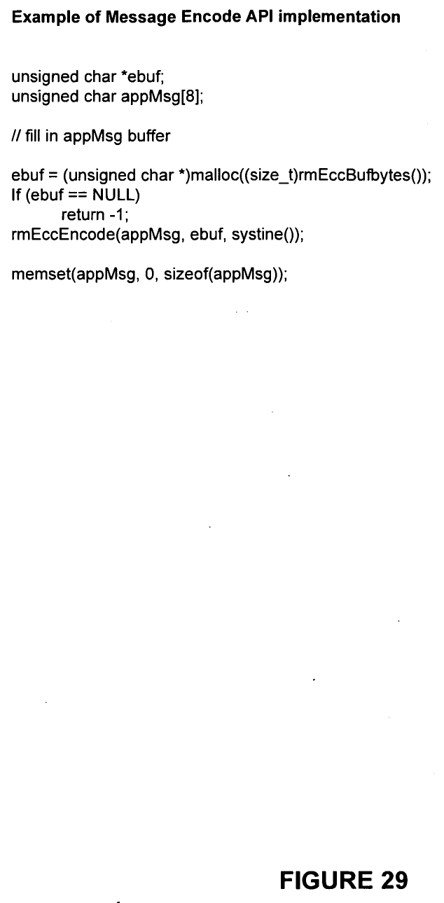

Definitions for the Message Encoding API are shown in FIG. 28. A typical implementation may look like that in FIG. 29.

One or more additional Message Encoding APIs may be used during the Insertion process. This function may return the number of bits in the Encoded Message.

It should be noted that the processing described in the example below is provided by the “C” language reference code. However, it is shown here for cases where the integrator is porting to an unsupported environment. The example is as follows:

int rm EccBufbits(void);

The RBW Carriers contained in the RBW-enabled content stream may each contain a bit count value. This value identifies which bit or bits in the Encoded Message upon which the placement of the Carrier into the video stream is conditioned. The bit-count value may increase with each represented bit. For example, it should not roll-over back to “0” at any time. The purpose is to remain neutral from the encoding method being used. Therefore, to match a Carrier's bit-count to a bit in the Encoded Message, a modulus operation may perform the following example as such:

U32 bitnum;
/* First we make sure we stay within bit array */
Bitnum = Carrier.bit_count % rmEccBufbits( );
/* Then we extract the bit */
return (Encoded Message[bitnum>>3] & (128>>(bitnum & 7))) ? 1 : 0;

Additional functions may also exist for encoding messages in special circumstances. Two types of cases may be supported: “security of work buffers” and “partial encoding.”

Under “security of work buffers,” temporary calculations may be stored in stack buffers during the encoding process. If the security of the environment demands that work buffers be at specific (e.g., secure) memory locations, then the host may choose to call a series of lower level encoding functions, rather than the single function described above.

Under “partial encoding,” it is possible to perform the encoding process over a series of calls, rather than at one time. This possibility may help support single-threaded, minimal horse-power environments where a new message may need to be periodically generated, but the system cannot afford to process the entire message at once.

3. RBW Inserter

The RBW Inserter (also referred to herein as Inserter or End-Point Inserter) is intended to operate in a content-end-point device, such as a consumer set-top box. It may be designed to function in devices with limited CPU power and memory. It may also employ coding techniques to enhance ease of portability.

The RBW Inserter may be located in a head-end device, an intermediate inserter in the distribution system, or in the consumer playback device (CPD). The insertion process may be codec agnostic, should only require a simple data copy operations, and may be implemented with virtually no time or computational overhead. These features are important because they enable insertion in any desired location in the distribution chain. For example, the Inserter could be used in an intermediate function, such as a virtual PVR server, inserting tens or hundreds of messages as it streams content to its clients. Also, the Inserter may be used in a compute-constrained consumer playback device, such as a portable media player or legacy set-top box, inserting the message at playback with virtually no impact on the power budget of the device.

The Inserter may operate on compressed, decrypted video. In a CPD, the Inserter may be located just prior-to, or embedded within, the video decoder. This placement allows for marking prior to decode, thus decreasing the possibility that a hacker might circumvent the watermarking system.

The Inserter presents numerous notable features. One, it is written in “C” language. Two, it tends not to use environment-dependent functions. Three, the lack of static variables allows multiple Inserter instantiations. Four, it tends to use a single, opaque buffer, which may be provided by the host. Five, it tends not to buffer content; all operations may be completed on each content portion as it arrives.

Since the Inserter generally does not use static variables, it can support multiple instances within the same task. However, to prevent the requirement for platform-specific thread synchronization, each instance should be single-threaded. Hence, the host should be careful not to allow combinations of calls to the same Inserter instance from multiple threads simultaneously. For example, calling RmBrd_Flush( ) while another thread is RmBrd_Process( ) can cause serious failure.

The main types of functions include Initialization Functions and Content Process Functions.

Initialization Functions may include Instance Size, Instance Open, Set Message Buffer and Instance Close.

In Instance Size, the Inserter may process the incoming stream as it is available. That is, it does not need to acquire an entire frame prior to processing. To support this function, the Inserter tends to require some buffer space for pending RBW Carriers and some state variables. These structures may be maintained in a handle, which should be allocated by the host. Supporting these structures, the Inserter API may provide a function, which returns the size of the handle, as shown in the following example:

/** RMBrd_InstanceSize
*
* Return the size of the handle buffer required
* to initialize this instance.
*/
Int RMBrd_InstanceSize(void).

In Instance Open, after allocating the instance handle and also acquiring the Encoded Message buffer, the host can initialize an instance of the Inserter. An example of such instance is described below:

/** RMBrd_Open
*
* Initialize an instance of an inserter
*
* Parameters

| | |
|---|---|
| * *pInstance | pre-allocated Buffer of size RMBrd_InstanceSize( ) |
| * *msgbuf | Pointer to an Encoded Message Buffer. |
| * | Defaults to Message-Field 0. |
| * | May be NULL if SetMsgBuf( ) is to be called. |
| * Return: 0 | Success |
| * −1 | Bad parameter |
| */ | |

int RMBrd_Open(void *pInstance, U8 *msgbuf);

In Set Message Buffer, during the course of operations, the host system may wish to renew the Application Message being inserted. To do so, it can generate a new Encoded Message (using the Message Encoding API) and establish the new Encoded Message buffer using the SetMsgBuf function. The following is an example of a SetMsgBuf function:

/** RMBrd_SetMsgBuf
*
* Initialize an instance of an inserter
*
* Parameters

| | |
|---|---|
| * *pInstance | Instance handle from Open( ) call |
| * *msgbuf | Encoded Message Buffer |
| * MessageField | Field 0 . . 3 to be used for insertion |
| * | Must always be 00 unless you KNOW this is |
| * | multi-field content. |
| * Return: 0 | Success |
| * −1 | Invalid Instance handle |
| * −2 | Invalid MessageField |
| */ | |

int RMBrd_SetMsgBuf(void *pInstance, U8 *msgbuf, U8 MessageField)

It should be noted that buffer (*msgbuf) containing the Encoded Message should remain valid until a new and/or another buffer is established by another call to SetMsgBuf. The buffer should not be freed while in use.

It should be further noted that this function may create an implied Flush( ).

In Instance Close, if the host has completed replacement based watermarking processing, the system should call the Close function and then de-allocate the instance-handle. The following is an example of making such call and de-allocation:

| /** RMBrd_Close | |
|---|---|
| * | |
| * Currently does nothing | |
| * | |
| * Parameters | |
| * pInstance | Instance handle from Open( ) call |
| * | |
| * Return: 0 | Success |
| */ | |

int RMBrd_Close(void *pInstance)

It is important to note that the instance should be de-allocated to avoid a memory leak.

Content Processing Functions may include Process Content, Process Carriers, and Flush Current State.

In Process Content, as each portion of incoming content becomes available, it can be passed to the Process function. The Process function performs two primary operations: (1) parse and buffer In-Frame RBW Carriers, which tends to clear carrier information in the content stream, and (2) make replacements in video, as required by the current Encoded Message. Upon return, the buffer at pInputBuffer may complete processing and may be passed to the system decoder. The following exemplifies a Process Content function:

/** RMBrd_Process
*
* Process incoming data for RM insertion
* This version does not allow the size of the packet to
* change, as it is most likely within a Transport Stream.
* User-Data bytes are zero'd, not removed.
*
* Parameters

| | |
|---|---|
| * pInstance | Instance handle from Open( ) call |
| * pInputBuffer | the content buffer to process |
| * Size | number of bytes to process |
| * | |
| * Return: 0 | No errors |
| * −1 | Bad instance parameter |
| */ | |

int RMBrd_Process(void *pInstance, U8 *pInputBuffer, int InputSize)

In Process Carriers, this function tends to be specifically for processing Out-of-Frame RBW Carriers. These Carriers may be delivered in a unique stream ahead of the content data that they reference. As portions of the Carrier stream arrive, they can be passed to the Inserter, validated, and queued for processing. Upon return, the data at pInputBuffer may compete processing and the buffer may be cleared. The following exemplifies a Process Carriers function:

/** RMBrd_Carriers
*
* Process incoming Carrier data for RM insertion
* Parameters

| | |
|---|---|
| * pInstance | Instance handle from Open( ) call |
| * pInputBuffer | the content buffer to process |
| * Size | number of bytes to process |
| * | |
| * Return: 0 | No errors |
| * −1 | Bad instance parameter |
| */ | |

int RMBrd_Carriers(void *pInstance, U8 *pInputBuffer, int InputSize)

In Flush Current State, the Inserter tends to maintain state during operation. To process a data discontinuity, such as a channel change or transmission drop, the host should call the Flush function to clear the current state. Such clearing may clear the Carrier queue and/or start the Inserter to look for the next start code. The following exemplifies a Flush Current State function:

| /** RMBrd_Flush | |
|---|---|
| * | |
| * The host wants to clear the queue and start over. | |
| * Called for things like channel change, trick play, etc. | |
| * Parameters | |
| * pInstance | Instance handle from Open( ) call |
| * Return: 0 | Success |
| * −1 | Bad parameter |
| */ | |

nt RMBrd_Flush(void *pInstance)

In addition to the typical inserter described above, there may be Special Case Inserters inserter embodiments, such as the NULL Inserter and the Intermediate Inserter.

The NULL Inserter is a special case of an End-Point Inserter. Normally, it processes the same RBW data structures, but tends not to be capable of marking content. Instead, it simply tends to clear the RBW Carrier Data so that it cannot be exposed outside of the secure environment.

This type of Inserter is likely to be useful for general deployment prior to the start of a system trial or extended roll-out. Such deployment may allow pre-processed content to be delivered beyond the trial or licensed devices without exposing the content to the risk of an RBW attack.

Another Special Case Inserter is the Intermediate Inserter. The Intermediate Inserter usually performs content marking but is not the last Inserter that will process content. Therefore, this Inserter generally does not clear the RBW Carrier Data. However, it has the option of swapping the RBW Replacement Data from the content back into the Carrier packaging, thereby allowing a future Inserter to do a complete message replacement.

It is important to note that since the RBW Carrier Data is not cleared by the Intermediate Inserter, it may become critical that the RBW Carrier Data be re-encrypted prior to leaving the secure environment. This action may help avoid exposure of sensitive RBW data.

There are two types of Intermediate Inserters: Additive Message Inserter and Swapped Message Inserter.

The Additive Message Inserter tends to be the simpler of the two. It is implementable as an option of the End-Point Inserter. A difference between the Additive Message Inserter and the End-Point Inserter is that under the Additive Message Inserter, the RBW Carrier Data is not cleared after processing, whereas such clearing exists for End-Point Inserter.

When using Additive Insertion, it is important to note that usually only a single message insertion can be performed without damage to the message. Each additional insertion may create further damage to one, more than one, or all messages, including the current message, as well as previous messages. While it is sometimes possible to recover more than one Additive Message, system robustness may be affected with each Additive Insertion.

It should also be noted that the RBW system designer may need to understand the effects of Additive Message Insertion on the robustness of the marks (i.e., the ability to recover the Application Message(s)).

The following exemplified API puts an End-Point Inserter into the Additive Message mode:

/** RMBrd_SetEndpoint
*
* Sets whether this Inserter instance should
* clear the Replacement Based Watermarking Carrier data.
*
* Parameters

| | |
|---|---|
| * pInstance | pre-allocated Buffer of size RMBrd_InstanceSize( ) |
| * IsEndpoint | TRUE = clear Replacement Based Watermarking |
| * | data, |
| * | FALSE = leave Replacement Based Watermarking |
| * | data |
| * | |
| * Return: 0 | Success |
| */ | |

int RMBrd_SetEndpoint(void *pInstance, int IsEndpoint)

The Swapped Message Inserter is a more complicated version of the Intermediate Inserter. Generally, the Swapped Message Inserter requires a different mode of API operation. However, it tends to be preferred over the Additive Inserter because of its robustness of message recovery.

Using Additive Inserter and Swapped Message Inserter present pros and cons. Advantages for using Additive Inserter include the use of standard Inserter API (e.g., no data buffering required), and the possibility to recover more than one Application Message. Disadvantages for using Additive Inserter include the decreased possibility of recovering any Application Message for each added message, and the demands for more marked content for message recovery. Advantages for using Swapped Message Inserter include similar robustness for each subsequent message (e.g., as robust as the first message) and demands for the least amount of marked content for recovery. Disadvantages for using Swapped Message Inserter include the maintenance of only the most recent message in the content, and in order to store the content back into the Carrier data, the content needs to be buffered if the content is not a data end-point (e.g., a latency incurred).

C. Replacement Based Watermarking Recovery System

The RBW Recovery System for non-source (blind) recovery may be provided as an application to replacement based watermarking licensees. It may operate in a range of modes, from “black box” to highly configurable professional versions.

One skilled in the art will recognize that embodiments of the present invention may practiced using modules that may be implemented in software, hardware, programmable hardware such as ASICS, FPGA's, etc, or a combination thereof. Modules may include a digital stream receiver configured to receive a digital stream from a source; a digital stream encoder and conditioner configured to generate an encoded and conditioned digital stream from the “digital stream” by encoding and conditioning the “digital stream”; and a replacement carrier generator configured to generating a replacement data carrier. The “replacement data carrier” should include replacement data and associated location data. The “location data” should specify locations for the “replacement data” to be selectively replaced with data into the “encoded and conditioned digital stream” at a later time.

Many of the elements described in the disclosed embodiments may be implemented as modules. A module is defined here as an isolatable element that performs a defined function and has a defined interface to other elements. The modules described in this disclosure may be implemented in hardware, software, firmware, wetware (i.e., hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL), such as VHSIC hardware description language (VHDL) or Verilog, that configure connections between internal hardware modules with lesser functionality on a programmable device. Finally, it needs to be emphasized that the above mentioned technologies are often used in combination to achieve the result of a functional module.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) of embedding a block authentication code in a data stream for authentication purposes. However, one skilled in the art will recognize that embodiments of the invention could be used to embed other types of information in the data blocks such as hidden keys or messages. One of many ways that this could be accomplished is by using a specific hash function that results in a value that either directly or in combination with other data can result in one learning this other type of information.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

The present invention can be made from a variety of materials, in a variety of shape and size, for a variety of purpose. The scope of the present invention is limited only by the claims as follows.

What is claimed is:

1. A video processor comprising:
a. a video content input channel;
b. a video content preprocessor capable of analyzing video content to identify at least one location for watermark embedding within the video content;
c. a replacement based watermarking (RBW) metadata creator, capable of generating RBW metadata for facilitating the watermark embedding, where at least one watermark being embedded represents at least part of a message;
d. a video content encoder capable of producing encoded video content;
e. an encoded video content output channel; and
f. an RBW metadata output channel.

2. The video processor according to claim 1, wherein the location is a dynamic watermark location capable of being initialized with at least one dynamic watermark having a default message.

3. The video processor according to claim 2, wherein the video content encoder avoids references to the at least one dynamic watermark location.

4. The video processor according to claim 1, wherein the video content preprocessor further includes a dynamic watermark location identifier.

5. The video processor according to claim 1, wherein the location is a static watermark location capable of being initialized with at least one static watermark having a default message.

6. The video processor according to claim 1, wherein the video content preprocessor further includes a static watermark location identifier.

7. The video processor according to claim 1, wherein the RBW metadata includes at least one encoded watermarked video content fragment, suitably formatted to replace an identified segment of the encoded video content.

8. The video processor according to claim 1, wherein the RBW metadata includes at least one watermarked video content fragment, suitably formatted to replace an identified segment of a baseband video, subsequent to decoding.

9. The video processor according to claim 1, wherein the RBW metadata denotes masking properties for at least one potential dynamic watermark location.

10. The video processor according to claim 1, wherein the video content encoder conditions the video content to facilitate the embedding of watermarked video fragments contained in the RBW metadata.

11. The video processor according to claim 1, further including a quantization controller configured for limiting degradation of the watermark.

12. The video processor according to claim 1, wherein the video processor employs a human visual system model.

13. The video processor according to claim 1, wherein the video content encoder dynamically adjusts parameters affecting compression.

14. The video processor according to claim 1, wherein the RBW metadata creator uses a set of configuration parameters to control the procedures that determine the location and composition of watermarks contained in or controlled by the RBW metadata.

15. A video processor comprising:
a. a video content input channel;
b. a video content preprocessor capable of analyzing video content to identify at least one location for watermark embedding within the video content;
c. a replacement based watermarking (RBW) metadata creator, capable of generating RBW metadata for facilitating the watermark embedding, where at least one watermark being embedded represents at least part of a message;
d. a video content encoder capable of producing encoded video content, wherein the RBW metadata is embedded into the encoded video content; and
e. a video content output channel.

16. The video processor according to claim 15, wherein the location is a dynamic watermark location capable of being initialized with at least one dynamic watermark having a default message.

17. The video processor according to claim 16, wherein the video content encoder avoids references to the dynamic watermark location.

18. The video processor according to claim 15, wherein the video content preprocessor further includes a dynamic watermark location identifier.

19. The video processor according to claim 15, wherein the location is a static watermark location capable of being initialized with at least one static watermark having a default message.

20. The video processor according to claim 15, wherein the video content preprocessor further includes a static watermark location identifier.

21. The video processor according to claim 15, wherein the RBW metadata includes at least one encoded watermarked video content fragment, suitably formatted to replace an identified segment of the encoded video content.

22. The video processor according to claim 15, wherein the RBW metadata includes at least one watermarked video content fragment, suitably formatted to replace an identified segment of a baseband video, subsequent to decoding.

23. The video processor according to claim 15, wherein the RBW metadata denotes masking properties for at least one potential dynamic watermark location.

24. The video processor according to claim 15, wherein the video content encoder conditions the video content to facilitate the embedding of watermarked video fragments contained in the RBW metadata.

25. The video processor according to claim 15, further including a quantization controller configured for limiting degradation of the watermark.

26. The video processor according to claim 15, wherein the video processor employs a human visual system model.

27. The video processor according to claim 15, wherein the video content encoder dynamically adjusts parameters affecting compression.

28. The video processor according to claim 15, wherein the RBW metadata creator uses a set of configuration parameters to control the procedures that determine the location and composition of the watermarks contained in or controlled by the RBW metadata.
